(19) United States
(12) Patent Application Publication
(10) Pub. No.: US 2007/0138077 A1
(43) Pub. Date: Jun. 21, 2007

(54) Fuel combustion

(75) Inventors: Nigel David Timms, Lancashire (GB); Baljit Singh, West Midlands (GB)

Correspondence Address: VENABLE LLP, P.O. BOX 34385, WASHINGTON, DC, 20043-9998, US

(73) Assignee: Maxsys Limited, Wesdt Midlands (GB)

(21) Appl. No.: 10/580,455

(22) PCT Filed: Nov. 17, 2004
(86) PCT No.: PCT/GB04/04814

§ 371 Date: May 24, 2006

(30) Foreign Application Priority Data
Nov. 28, 2003 (GB) 0327643.3

(51) Int. Cl. C02F 1/48

(52) U.S. Cl. 210/222; 431/12

(57) ABSTRACT

This invention relates to a magnetic fluid treatment device comprising at least one fluid channel, the or each fluid channel having at least two peripherally located magnets, the device being adapted to co-operate with a fluid supply conduit, so that, in use, fluid flowing through the fluid channel is subjected to a magnetic field; wherein the at least two magnets are located on opposite sides of the or each fluid channel and have a separation of less than about 90 mm. The invention further relates to a magnetic fluid treatment device comprising at least one fluid channel, the or each fluid channel having at least one peripherally located magnet, wherein the at least one magnet is removably received in a body section of the device.

### FIELD OF THE INVENTION

This invention relates to apparatus for magnetic treatment of fuel prior to being supplied to the burners of a unit for combustion, particularly, but not limited to, apparatus and a method for the magnetic treatment of fuels.

### BACKGROUND TO THE INVENTION

The magnetic treatment of fuels prior to burning in order to improve fuel combustion efficiency is already known. Many simple devices and apparatus for magnetising fossil fuels exist where magnets are secured around a fuel pipe at various angular separation, for example 90°.

Further devices have been disclosed where the magnets are held within the fuel pipe (for example EP 0976682-A2). This arrangement overcomes some of the disadvantages described above for simpler devices where the magnets are secured to the exterior of the fuel pipe. However, due to the lack of understanding of the mechanism in magnetising fuel and the resulting increase in combustion efficiency, such devices were not optimised in terms of the various factors involved.

Previous devices have been either installed straight in-line or are complex customised products that use intricate flow paths for the fuel. Straight in-line devices are known at relatively low cost; however, they have not yet shown significant fuel efficiency improvements across a wide range of combustion systems. Other devices have proved effective, but too expensive in comparison to the cost savings made from the increased fuel efficiency.

Combustion, from a chemical perspective, is the rapid high-temperature burn of fuels involving the oxidation of carbon to carbon monoxide or carbon dioxide. The level of emission of carbon monoxide is known to be broadly indicative of the efficiency of the combustion process, as it is a result of the incomplete oxidation of carbon fuels.

Any sulphur present in the fuel oxidised to the dioxide or trioxide form depending on the conditions, whilst nitrogen if present, remains unreacted or is converted to nitrogen oxides. Most combustion reactions occur in the gas phase, except for the burning of the fixed carbon in solid fuels.

The advantages of magnetisation have been known for over a century following the discovery by Dr Van der Waals that improvements in combustion were noticed when fuel was passed through a magnetic field prior to combustion.

### SUMMARY OF THE INVENTION

According to a first aspect of the invention, a magnetic fluid treatment device comprising at least one fluid channel, the or each fluid channel having at least two peripherally located magnets, the device being adapted to co-operate with a fluid supply conduit, so that, in use, fluid flowing through the fluid channel is subjected to a magnetic field; wherein the at least two magnets are located on opposite sides of the or each fluid channel and have a separation of less than about 90 mm.

According to a second aspect of the present invention, there is provided a magnetic fluid treatment device comprising at least one fluid channel, the or each fluid channel having at least one peripherally located magnet; the device being adapted to cooperate with a fluid supply conduit, so that, in use, fluid flowing through the fluid channel is subjected to a magnetic field; the ratio of the cross-sectional area of the fluid supply conduit to the total cross-sectional area of the fluid channel or all of the fluid channels being in the range 1:1.1 to 1:2.8.

According to a third aspect of the invention, a magnetic fluid treatment device comprising at least one fluid channel, the or each fluid channel having at least one peripherally located magnet, the device being adapted to co-operate with a fluid supply conduit, so that, in use, fluid flowing through the fluid channel is subjected to a magnetic field; wherein a ratio of the width of the at least one fluid supply conduit to the length of a section of the at least one fluid channel along which the at least one magnet extends is approximately in the range of 1:20 to 1:40.

According to a fourth aspect of the invention, a magnetic fluid treatment device comprising at least one fluid channel, the or each fluid channel having at least one peripherally located magnet, the device being adapted to co-operate with a fluid supply conduit, so that, in use, fluid flowing through the fluid channel is subjected to a magnetic field; wherein a magnetic field strength in a section of the at least one fluid channel along which the at least one magnet extends is between 0.02T and 1.0T.

For any of the above aspects the following are preferred features.

The fluid may be a fuel. The fluid may include materials that have fluid properties, such as pulverised coal, gas and oil.

The ratio of the cross-sectional area of the fluid supply conduit to the total cross-sectional area of the or all of the fluid channels may be in the range 1:1.2 to 1:2.4, preferably 1:1.6 to 1:2.4, and more preferably 1:1.8 to 1:2.2.

Where at least two magnets are provided on opposite sides of the or each fluid channel, the separation may be less than about 80 mm, preferably less than about 75 mm, more preferably about equal to 60 mm, or less.

The ratio of the width of the at least one fluid supply conduit to the length of a section of the at least one fluid channel along which the at least one magnet extends may be approximately in the range 1:22 to 1:30, preferably about 1:24, to 1:26, and most preferably about 1:24.

A magnetic field strength in a section of the at least one fluid channel along which the at least one magnet extends may be between approximately 0.025T and 0.5T and more preferably between 0.1T and 0.5T.

According to fifth aspect of the invention, a magnetic fluid treatment device comprises at least one fluid channel, the or each fluid channel having at least one peripherally located magnet, wherein the at least one magnet is removably received in a body section of the device.

The body section is preferably non-ferrous. The body section may be made of ferritic or electric steel.

The device may incorporate at least one internal magnet within the fluid channel. Said at least one internal magnet may be located in a section sealed from the fluid channel. The at least one internal magnet may be housed in a non-magnetic section of the body section.

The provision of removable magnets is advantageous because the magnets can easily be reconfigured or replaced to change the characteristics of the device.

The device may be fitted within an existing fluid supply conduit.

The device may be made from non-magnetic material such as steel, stainless steel, copper, aluminium, copper-nickel alloys, plastics or carbon fibre, for example.

The device may incorporate internal replaceable magnetic cartridge/s.

The length of the device may be 10 cm to 400 cm. The internal removable magnetic cartridge/s may have a length of 5 cm to 350 cm.

The internal replaceable magnetic cartridge/s may be held in position inside the device by retaining means into which the removable magnetic cartridge/s may slot.

The internal replaceable magnetic cartridges may split the fluid channel into subsidiary channel/s.

The ratio of the fluid flow area of the device and/or channel/s thereof to the fuel flow area of the fluid supply conduit may be 1:1.1 to 1:25, preferably about 1:2.

The internal removable magnetic cartridge/s may include at least one flow director between adjacent subsidiary channel/s.

The internal replacement magnetic cartridge/s may be substantially as wide as the fluid channel, for example +/−10% wider or narrower.

The internal magnetic cartridge/s may contain at least one magnet.

The internal magnetic cartridge/s may form a conduit made of a material that will isolate and/or contain the magnets, such as a non magnetic material.

The internal magnetic cartridge/s may have a separation plate made of metal that will isolate the magnets within the cartridge/s, which metal may be a ferritic steel or electric steel.

The or each fluid channel may have external removable magnetic cartridge/s located on an exterior of the device.

The external removable magnetic cartridges may be located within an external housing. The external housing may comprise a plurality of sections, which may be arranged so that they can be secured together.

The external housing may be located around the remainder of the device and may be held by retaining means to the device.

The external housing may be removable to allow for the external removable magnetic cartridge/s to be installed or removed.

The external housing may be of a ferritic steel or electric steel.

The external replacement magnetic cartridge/s may be substantially as wide as the fluid channel, preferably + or −10%.

The external magnetic cartridge/s may contain at least one magnet.

The external magnetic cartridge/s may be a conduit made of a material that will isolate and/or contain the magnets, such as a non magnetic material.

The magnets inside the internal magnetic cartridge and external magnetic cartridge may be arranged differently depending on the fuel that may pass through the magnetic field of the cartridge/s and a ratio of the width of the fluid channel to the length of a section of the fluid supply conduit along which the at least one magnet extends (dwell length ratio).

Magnets suitable for use in any aspect of this invention include sintered ferrite magnets, rare earth magnets, samarium cobalt magnets, sintered neodymium iron boron magnets, alnico magnets and nickel magnets, for example.

The number of magnets inside the external magnetic cartridge/s and/or internal magnetic cartridge/s may vary dependent upon the ratio of the width of the fluid supply conduit to the length of a section of the at least one fluid channel along which the at least one magnet extends (dwell length ratio).

The arrangement of the polarity of the magnets inside the internal magnetic cartridge/s and external magnetic cartridge/s may change according to the fuel type and quality, fuel temperature, fuel pressure, time between magnetisation and combustion and required dwell length ratio of the device.

Preferably the magnetic field/s is applied substantially at right angles to the flow of fuel.

At least one end of the device may be attached to a cone that may reduce the size of the conduit to the size of the pipe work that the device may be fitted to.

At least one end of the device may be attached to an access flange.

The access flange may be of a size to allow the internal removable magnetic cartridge/s to be placed or removed from the fluid channel.

At least one end of the fluid channel may have a second access flange attached to a cone that may reduce the size of the fluid channel to the size of the pipe work that the device may be fitted to.

The two access flanges may be attached to each other to form a continuation of the fluid channel.

Flanges and/or screw threads may be attached to the end cones, which may allow the unit to be installed into the pipe work where the unit may be fitted.

According to another aspect of this present invention at least one or more devices may be fitted into the existing pipe work to maintain the dwell length ratios required to ensure that efficiency savings are achieved.

A conduit branch may be used to enable one or more devices to be installed in a bank of devices.

All of the features described herein may be combined with any of the above aspects, in any combination.

### BRIEF DESCRIPTION OF THE DRAWINGS

For a better understanding of the invention, and to show how embodiments of the same may be carried into effect, reference will be made, by way of example, to the accompanying diagrammatic drawings, in which:—

FIGS. 1a, 1b, and 1c show graphs of fuel flow and pressure for the duration of the trials;

FIGS. 2a, 2b, and 2c show graphs of fuel temperature at the burner tip and at a point upstream of the burner for the duration of the trials;

FIGS. 3a, 3b, and 3c show graphs of windbox temperature for the duration of the trials;

FIGS. 4a, 4b, and 4c show graphs of the total air flow to the burner for the duration of the trials;

FIGS. 5a, 5b, and 5c show graphs of the primary, secondary and tertiary fuel ratio for the duration of the trials;

FIGS. 6a, 6b, and 6c show graphs of the combustion chamber temperature for the duration of the trials;

FIGS. 7a, 7b, and 7c show graphs of the fluegas duct temperature profiles for the duration of the trials;

FIGS. 8a, 8b, and 8c show graphs of the stack oxygen levels emissions for the duration of the trials;

FIGS. 9a, 9b, and 9c show graphs of the carbon dioxide emissions levels for the duration of the trials;

FIGS. 10a, 10b, and 10c show graphs of the carbon monoxide emissions levels for the duration of the trials;

FIGS. 11a and 11b show graphs of the carbon monoxide vs. stack oxygen differentiated by use (or otherwise) of the magnetic enhancement device;

FIG. 12 shows a graph of the carbon monoxide level as a function of secondary:tertiary air ratio for day 2 of the trials;

FIGS. 13a, 13b, and 13c show graphs of the SO₂ levels as measured at the U tube outlet for the duration of the trials;

FIGS. 14a, 14b, and 14c show graphs of the NOₓ levels for the duration of the trials;

FIGS. 15a and 15b show graphs of the nitrogen monoxide level against stack oxygen level for the duration of the trials;

FIGS. 16a and 16b show graphs of nitrogen monoxide levels vs. the secondary:tertiary air ratio for the duration of the trials;

FIGS. 17a, 17b, and 17c show graphs of the basic variations in temperature during the course of the trials;

FIG. 18a shows the combustion chamber temperature data as a function of stack oxygen content with magnet and dummy unit results differentiated for the duration of the trials;

FIGS. 19a and 19b show graphs of secondary:tertiary air flow ratios versus stack oxygen levels during the duration of the trials;

FIG. 20 show a graph of heat input and heat recovered during day 2 of the trials;

FIG. 21 shows a diagrammatic sectional side view of the first embodiment of the magnetic fluid treatment device;

FIG. 22 shows a sectional view across the magnetic fluid treatment device;

FIG. 23 shows a sectional side view of an external magnetic cartridge;

FIG. 24 shows a sectional side view of an internal magnetic cartridge; and

FIG. 25 shows a plan view of multiple magnetic fluid treatment devices.

### DESCRIPTION OF THE PREFERRED EMBODIMENTS

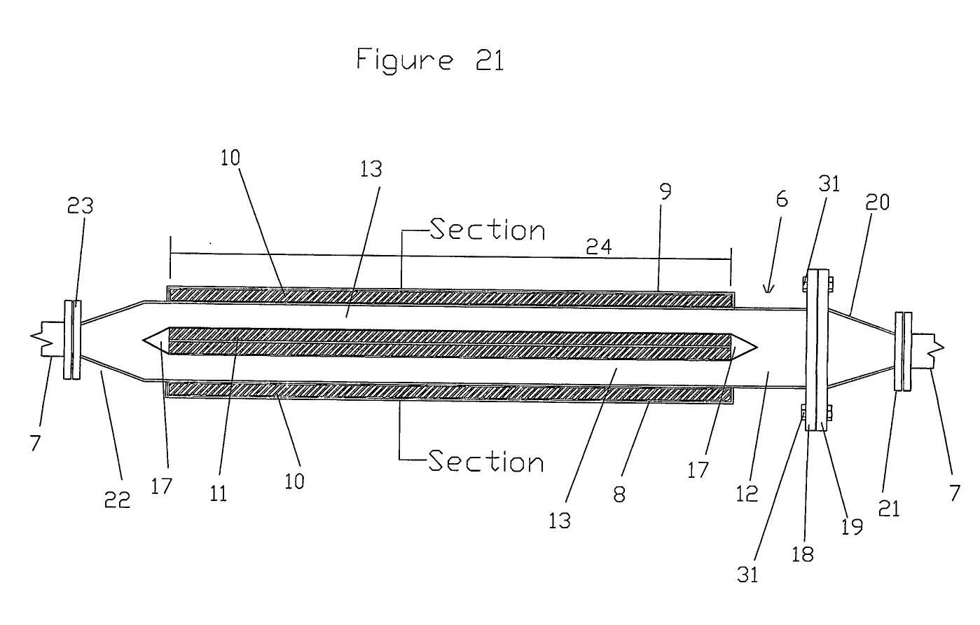

In FIG. 21 a fuel treatment device 6 is arranged to be fitted in an existing fuel supply pipe 7 and comprises two peripheral box sections 8 and 9 respectively into which a plurality of external magnetic cartridges 10 are inserted. The fuel treatment device 6 also comprises an internal magnetic cartridge 11 which is inserted inside the conduit 12 forming a plurality of fuel flow channels 13 with a specified magnetic field gap. The device may also be fitted to new pipe work, such as in a new plant installation. The ratio of the total cross-sectional area of the fluid flow channels 13 to the cross-sectional area of the fluid supply conduit is approximately 1:1.5 to 1:2.5. The distance between the magnetic cartridges 10 and 11 is approximately 10-60 mm. The ratio of the width of the fluid supply pipe 7 to the length of a section of the fluid channels 13 along which the magnetic cartridges 10, 11 extend is in the range 1:30 to 1:40.

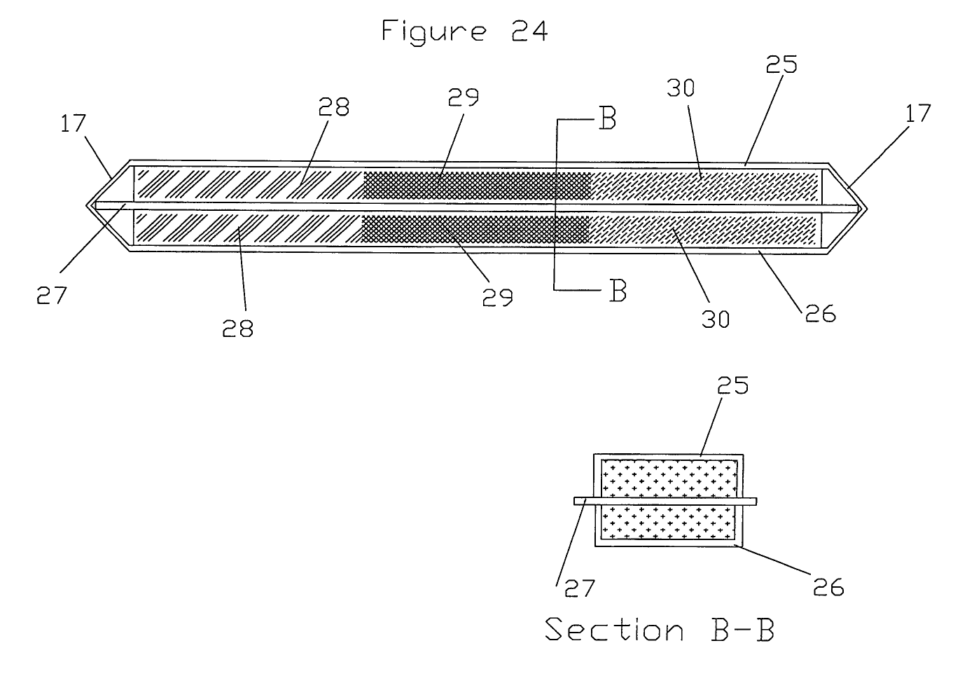

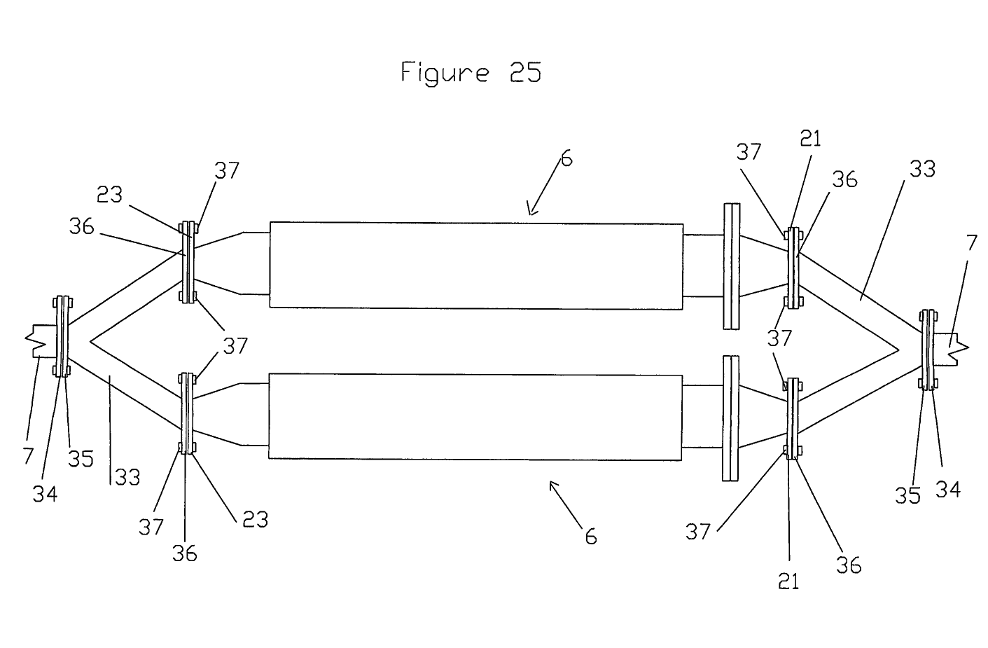

Fuel flowing through the fuel treatment device 6 through the channels 13 on its way to a fuel combustion point or the like (not shown) is affected by the magnetic fields of the magnets 28, 29, 30 (FIGS. 23, 24) within the internal magnetic cartridge 11 and external magnetic cartridges 10. Which results in a more efficient burning process, as described below.

The fuel treatment can be fossil fuel, such as oil and gas or equivalent fuel types.

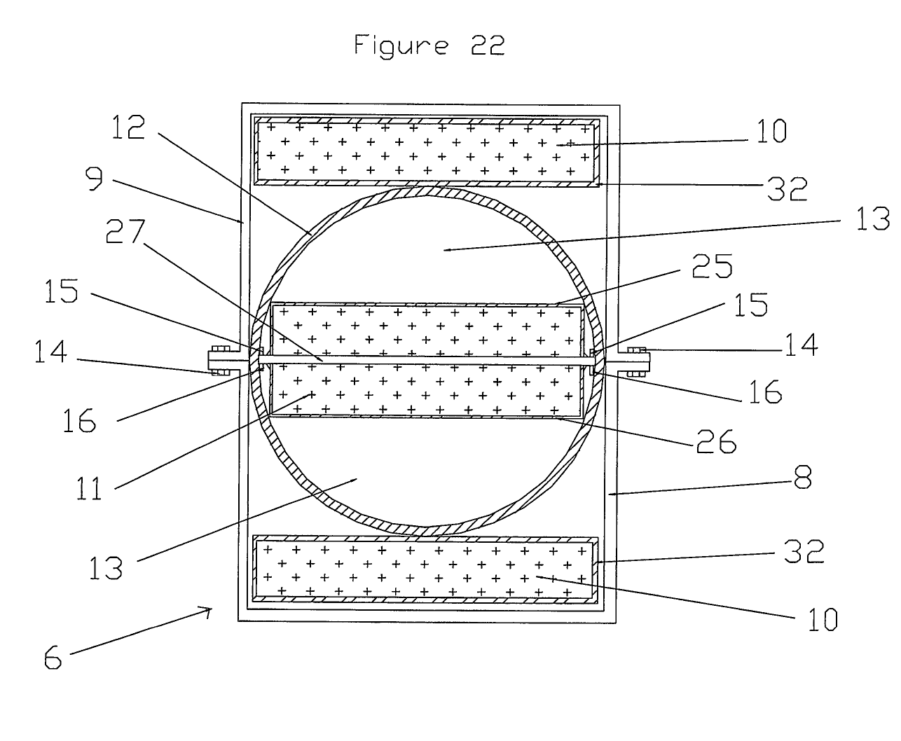

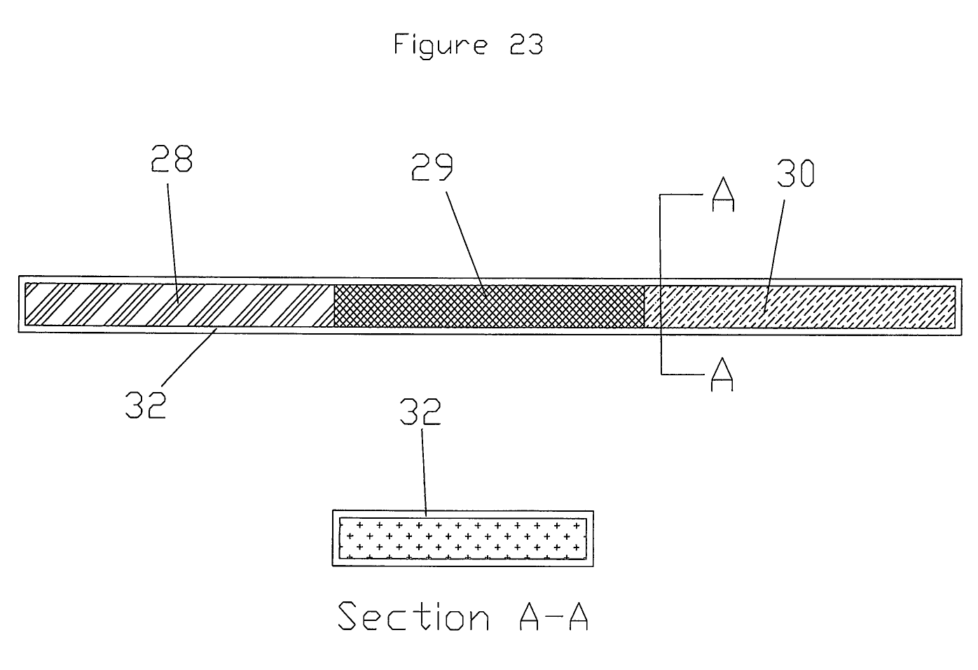

In more detail, the fuel treatment device 6 comprises two portions 8 and 9 (see FIG. 22) which form a removable box section secured together around the conduit 12 by means of bolts 14. The portions 8 and 9 also secure in place the external magnetic cartridges 10 holding them parallel to the conduit 12. The internal magnetic cartridge 11 is secured in place inside the conduit 12 between upper and lower mountings 15, 16, which allow the internal magnetic cartridge to be slid in and out when required.

The conduit 12 may be made of non ferritic steel or non electric steel and is generally termed a non magnetic conduit, which is chosen because it dose not become magnetised over time and does not alter the magnetic properties of the field produced by the external magnetic cartridges 10 or internal magnetic cartridge 11. Materials having similar properties could also be used.

Returning to FIG. 21 the internal magnetic cartridge 11 has a leading and trailing flow director 17 generally termed a baffle which serves to channel fuel flowing through the fuel treatment device 6 into the channels 13 and to ensure a smooth flow of the fuel.

One end of the conduit 12 is fitted with a flange 18 which has an opening the same internal diameter as the conduit 12 to allow the internal magnetic cartridge 11 to be slid in and out of the fuel treatment device 6. A second flange 19 that also has an opening the same internal diameter as the conduit 12 is fitted to a conduit 20, which may be in the shape of a cone reducing the conduit 12 down to the size of the fuel supply pipe 7. The conduit 20 may be fitted with a second flange 21 or be threaded (not shown) depending on the arrangement required for fitting to the fuel supply 7. Flanges 18 and 19 may be fitted together using bolts 31.

At the other end of the conduit 12 is fitted a conduit 22 which may be in the shape of a cone reducing the conduit 12 down to the size of the fuel supply pipe 7. The conduit 22 may be fitted with a flange 23 or be threaded (not shown) depending on the arrangement required for fitting to the fuel supply 7.

The flange 18, flange 19 conduit 20 flange 21, conduit 22 and flange 23 may be made of non ferritic steel or non electric steel (generally termed non magnetic), which is chosen because it dose not become magnetised over time and will not dissipate the magnetic field produced by the external magnetic cartridge 10 and internal magnetic cartridge 11 back along the existing supply pipe 7. It will also not dissipate the magnetic effect on the fuel.

The dwell length 24 of the fuel treatment device 6 will be determined by the supply pipe 7 flow area, the magnetic field gap, and the time between magnetisation and combustion, and may also take into consideration the fuel flow rates, fuel pressure and fuel type.

The flow area and width of the channels 13 will be determine by the supply pipe 7 flow area, the magnetic field gap, and the time between magnetisation and combustion, and may also take into consideration the fuel flow rates, fuel pressure and fuel type.

FIG. 22 shows a cross section of the fuel treatment device 6. The external magnetic cartridges 10 comprise of a conduit into which a plurality of magnets 28, 29, 30 (FIG. 23) is inserted. The conduit 32 may be made of non-ferritic steel or non-electric steel generally termed non-magnetic.

The internal magnetic cartridge 11 comprises a upper and lower peripheral box sections 25 and 26 and a separation plate 27. The upper and lower peripheral box sections are fitted to the separation plate 27 to form two conduits into which a plurality of magnets 28, 29, 30 (FIG. 24) are inserted. The upper and lower box sections 25 and 26 may be made of non-ferritic steel or non-electric steel generally termed non-magnetic. The separation plate 27 may be made of ferritic steel or electric steel generally termed magnetic.

A second embodiment of fuel treatment device 6 is shown in FIG. 25 the fuel treatment device 6 is constructed in a similar way except that there may be more than one fuel treatment device 6 fitted in a bank referred to as a matrix. FIG. 25 shows two fuel treatment devices 6 in a matrix. The conduit 33 branches from one conduit diameter, which is the same diameter as the fuel supply pipe 7 to two conduit diameters, which are the same as the fuel treatment device 6 conduit diameter. The single end of the conduit 33 is fitted to a flange 35, which in turn may be bolted 37 to the flange 34 of the fuel supply pipe 7. The double ends each have a flange 36 fitted to the conduit 33 which in turn may be bolted 37 to the fuel treatment device 6.

The conduit 33 flange 35 and flanges 36 may be made of non-ferritic steel or non-electric steel generally termed non-magnetic.

FIG. 25 shows a double matrix of fuel treatment devices 6, but there may be a number of devices installed in 3, 4, 5, 6, etc branches or matrices. The number of fuel treatment devices 6 will depend on the fuel flow area of the fuel supply pipe 7, the magnetic field gap, the dwell length, the fuel type and quality, the time between magnetisation and combustion.

Extensive testing of a number of magnetic fluid treatment devices with varying factors has enabled the construction of a device which gives particularly advantageous fuel efficiency compared to earlier devices.

Previous devices have resulted in uneven magnetisation due to the field only extending across a portion of the fuel pipe. For magnetic fluid treatment devices where the magnets are secured around a fuel pipe at angular separation of 90° disadvantages are observed for pipes of diameter greater than 5 cm. This is due to the magnetic field passing through a smaller portion of the fuel due to attenuation of the field. Magnets may also be secured around the pipe at different angular separations.

The factors which have been found to play an important role in governing the level of fuel efficiency gained include the strength of magnetic field, the magnetic field gap, the polar configuration and alignment of magnets, the dwell time (the time in which the fuel is subjected to the magnetic field), the time between magnetisation and combustion, fuel pressure and the overall shape of the fuel channels within the device. In particular, the evenness of the magnetic field through which the fuel flows has been found to be particularly relevant.

In order to determine the effectiveness of the magnetic fluid treatment device, a series of tests were undertaken on the Powergen Combustion Test facility at Ratcliffe, Nottinghamshire, UK.

Tests were undertaken with the magnetic fluid treatment device on the 1 MWₜₕ test facility using Heavy Fuel Oil fired on a single burner firing horizontally into a combustion chamber.

As with all firing tests of this nature, the quality of the burner, its installation and set-up are of very high quality, with the efficiency of combustion well in excess of the typical industrial applications where the magnetic fluid treatment device would find its greatest applicability. A protocol was established to effectively de-rate the burner to provide more representative combustion conditions.

Having established the burner characteristics, a variety of tests were undertaken to establish firstly the base-line performance of the burner before moving on to investigate the impact of the magnetic fluid treatment device on overall performance, as discussed below.

The 1 MWₜₕ Combustion Test Facility at Powergen's Ratcliffe research site is designed to reproduce the flame conditions, furnace residence times and temperature profiles found in large water tube boilers as used in the power generation industry.

The test rig is provided with a variety of access ports that allow sampling and measurement. Full automatic data logging facilities are provided.

The test rig was fitted and equipped with a horizontal single Y jet twin fluid atomiser burner firing on Heavy Fuel Oil.

The system allowed full independent control of primary, secondary and tertiary air flows in to the combustion chamber. In the standard configuration, combustion air is preheated and the tertiary: secondary air split is 3.5:1.

Initial test results showed the configuration to be extremely efficient with extremely low CO levels. Both the absolute values and the excess oxygen at which the CO values are seen to increase are extremely low as compared to a typical industrial burner.

In order to attempt to provide a more realistic representation of a typical industrial boiler, the burner was de-tuned to increase the overall CO concentration and to raise the CO breakpoint. These effects were achieved by using ambient temperature (rather than preheated) combustion air.

These changes had an effect on the overall combustion performance. The main effect was on CO breakpoint which moved from about 0.2% oxygen to around 0.6%. At oxygen concentrations in excess of about 1%, these changes had no effect.

The whole problem of burner set-up and establishing a valid reference condition has always plagued trials of magnetic fluid treatment devices. It has always been recognised that combustion enhancement devices are most likely to deliver the greatest benefits when applied to typical industrial applications.

A new burner correctly installed, set-up, operated and maintained will give extremely high efficiency and low CO emissions. Typical industrial burners are characterised by relatively poor set-up and maintenance and correspondingly higher emission rates.

Although the burner was de-tuned to give higher CO rates and to reduce the CO break-point, the results were still extremely good as compared to typical industrial burners where typical stack oxygen levels are around 3-8% (dry) and CO levels 20-50 ppm.

Base-line measurements for the de-rated burner were obtained with the fuel flowing through a dummy unit for stack oxygen concentrations of 0.3, 0.6 & 0.9%.

Measurements included heat flux, temperature at stages down the fluegas duct, CO levels, CO breakpoint and particulate loadings.

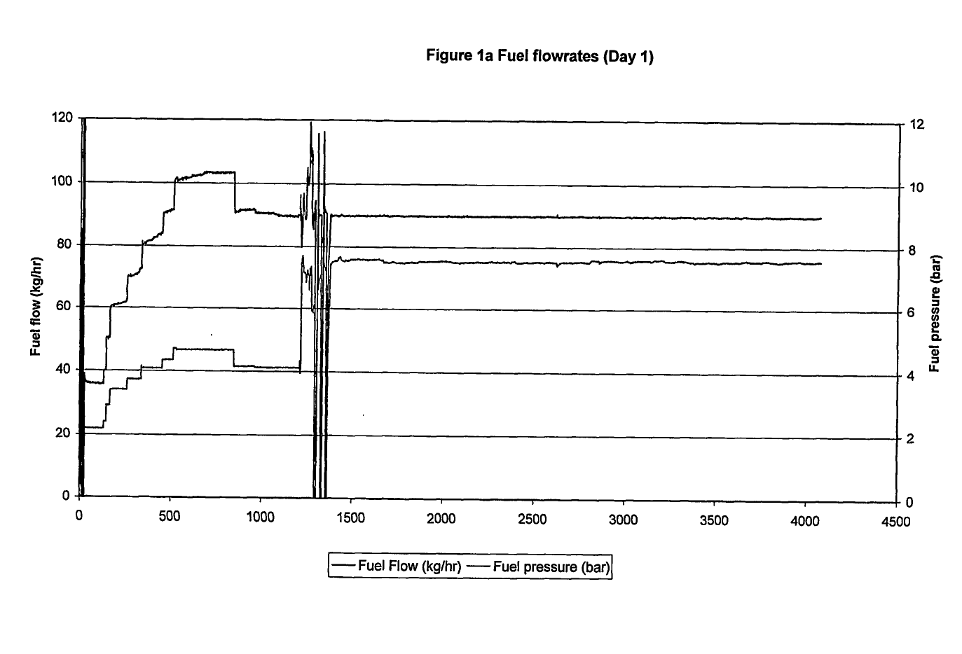

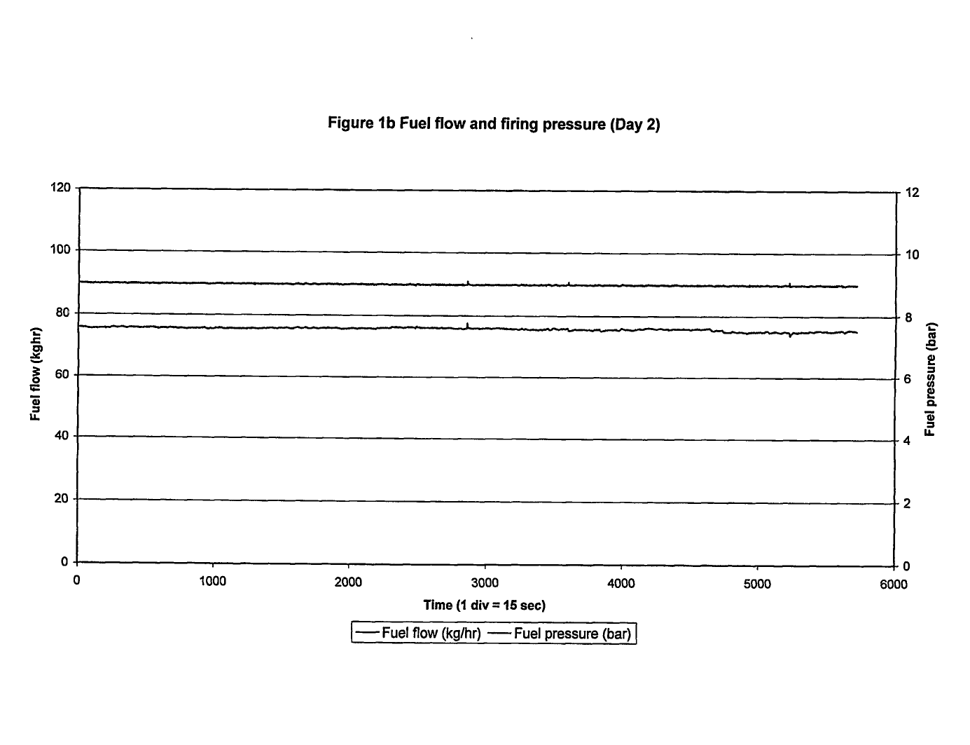

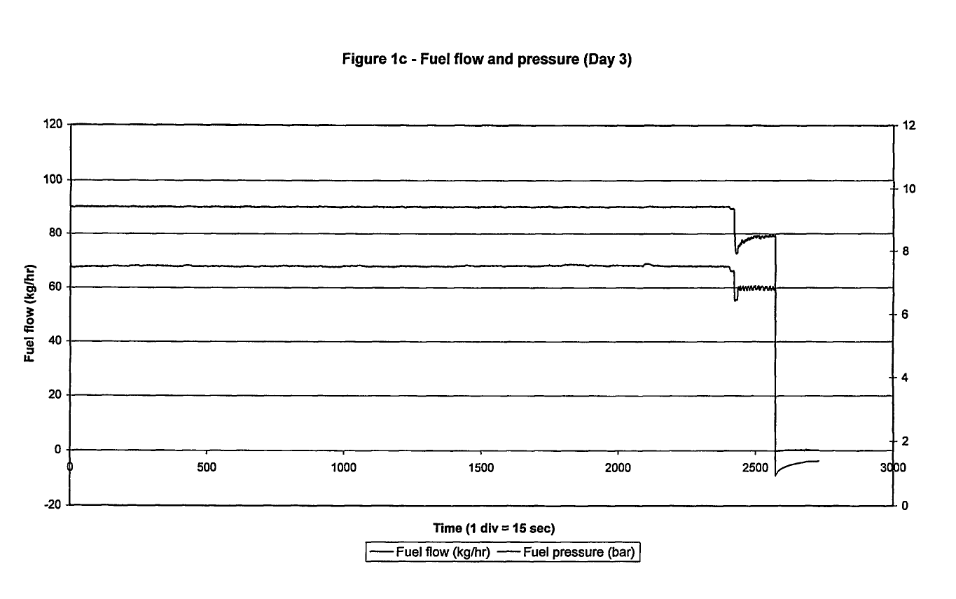

FIGS. 1a, 1b, and 1c show fuel flow and pressure for the duration of the trials. As can be seen, apart from during the initial start-up, both flow and pressure were extremely stable. It can therefore be concluded that any subsequent changes noted are independent of either of these parameters.

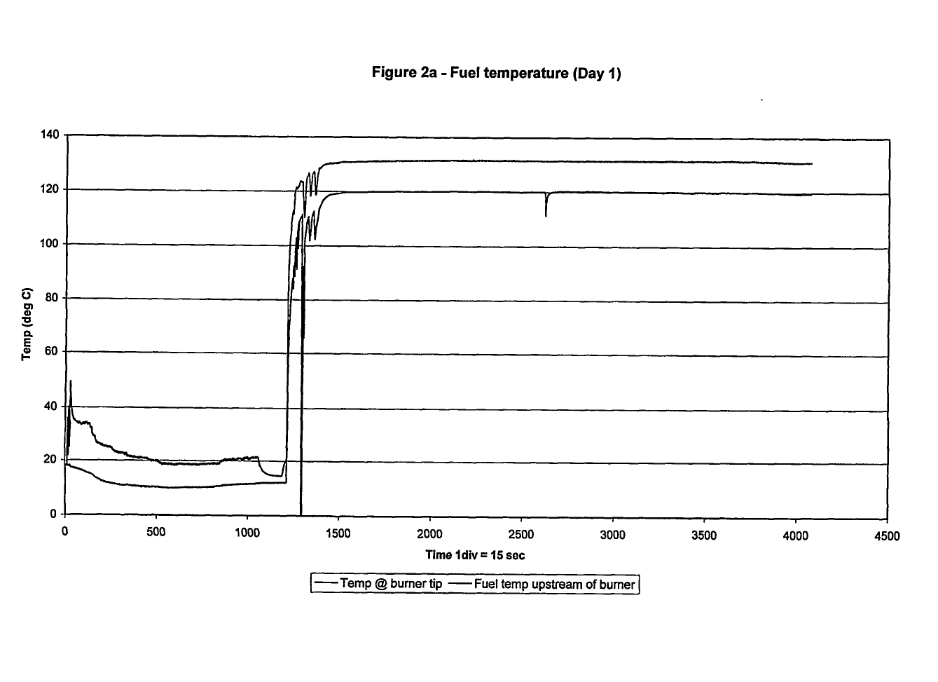

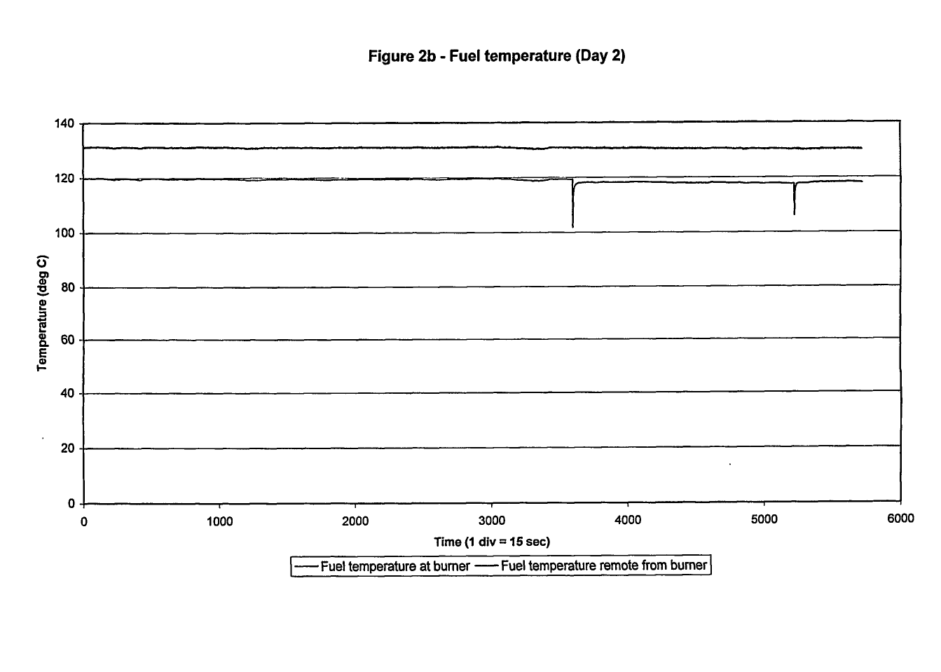

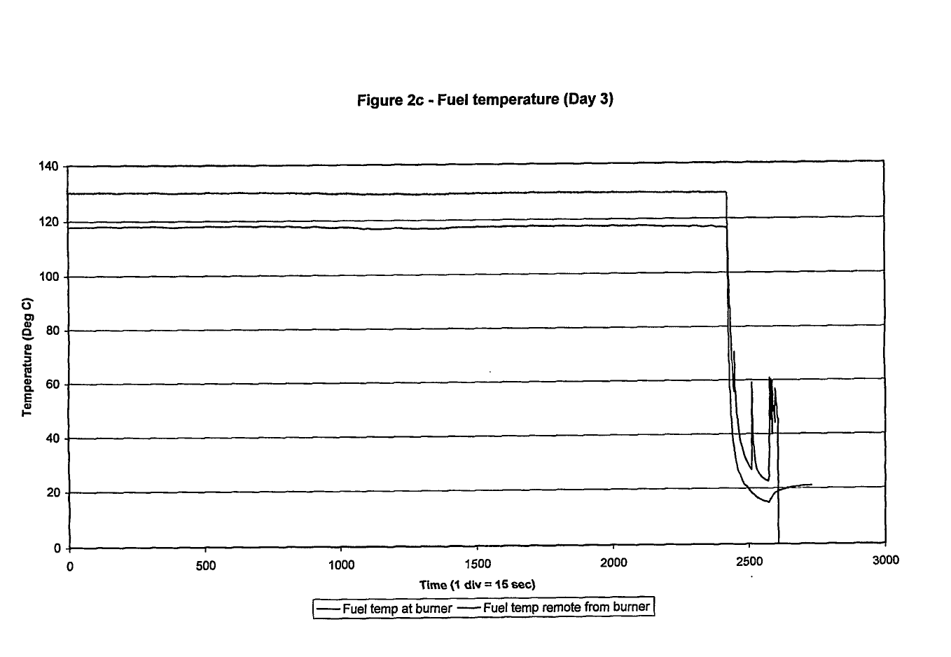

FIGS. 2a, 2b, and 2c show fuel temperature at the burner tip and at a point in the supply line upstream of the burner.

Some very minor changes (around 1° C.) are apparent but these are of no consequence in terms of impact on the overall heat balances or performance of the system.

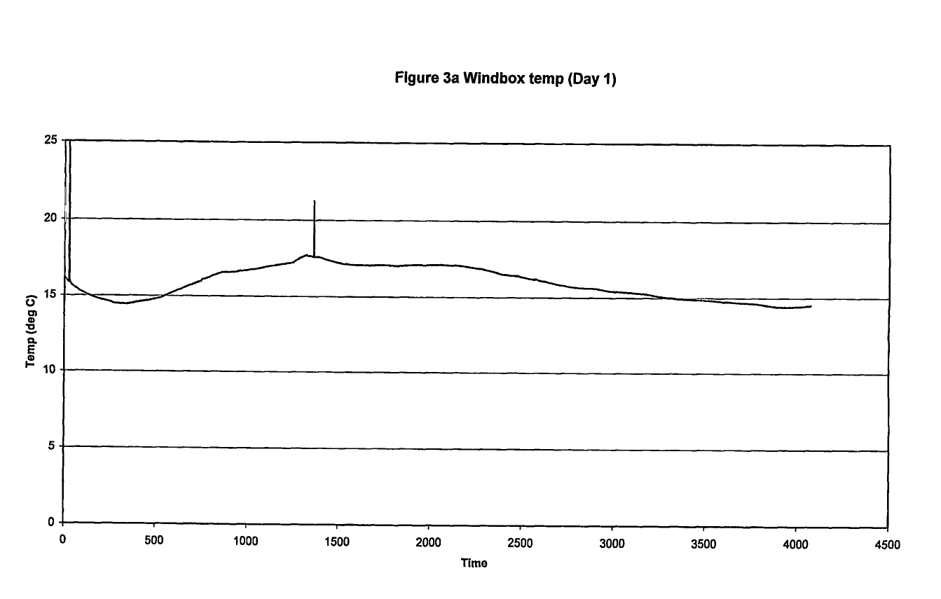

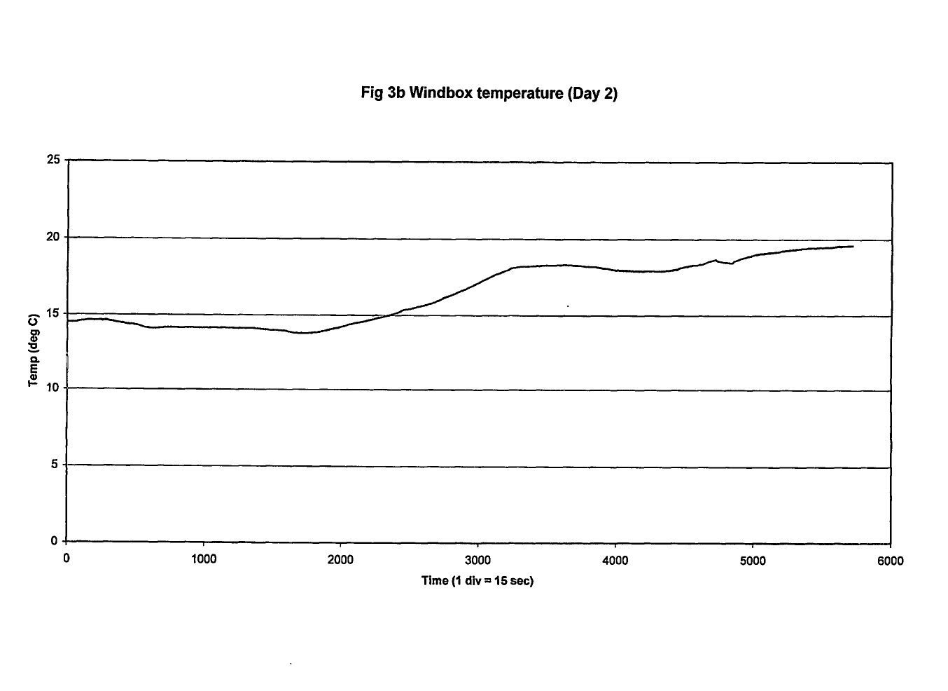

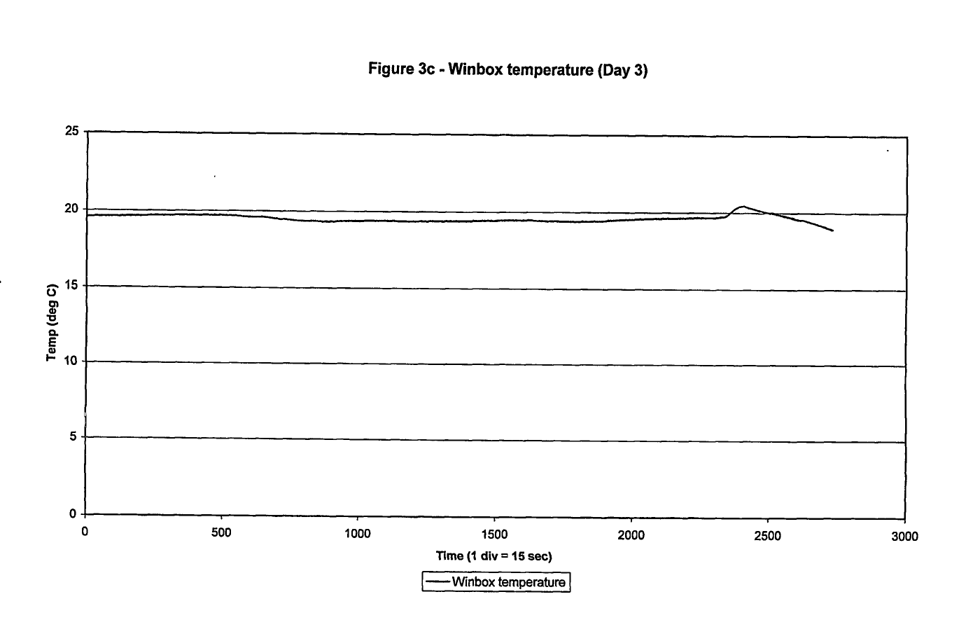

FIGS. 3a, 3b, and 3c show the windbox temperature. As with the fuel temperature, there is some variability but insufficient to significantly affect the overall heat balances or performance of the system.

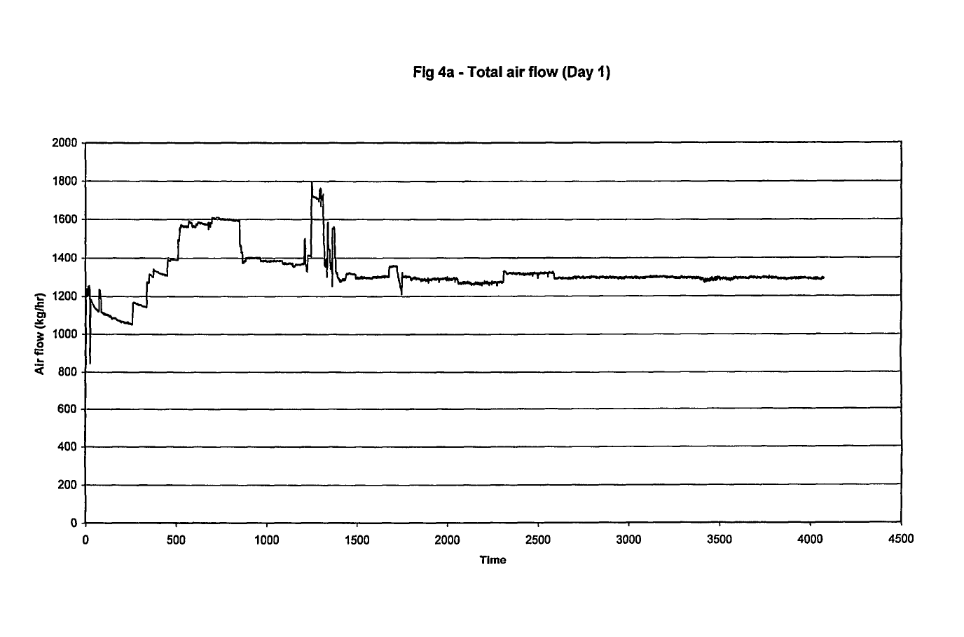

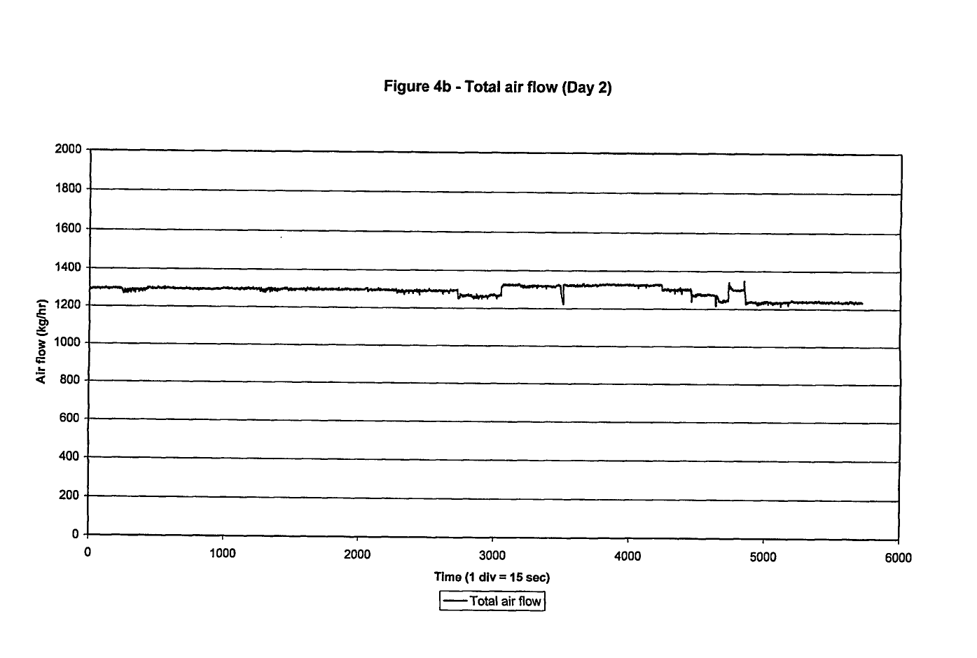

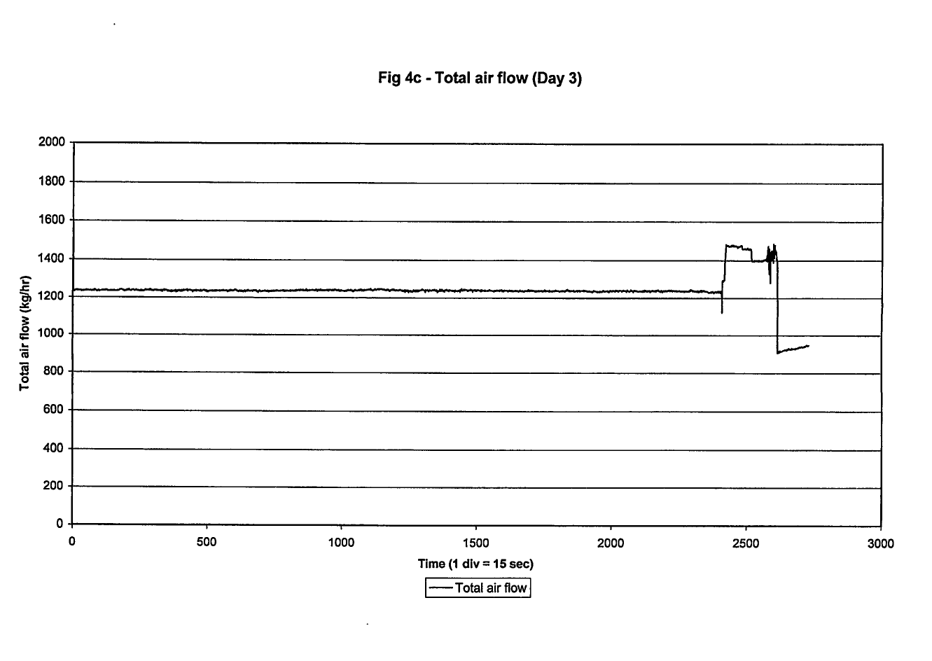

FIGS. 4a, 4b, and 4c show the total air flow to the burner (primary, secondary and tertiary) and once the system is set-up and stabilised, with the exception of the variations in total air flow required to achieve different excess oxygen levels, it can be seen that the air flow is very consistent.

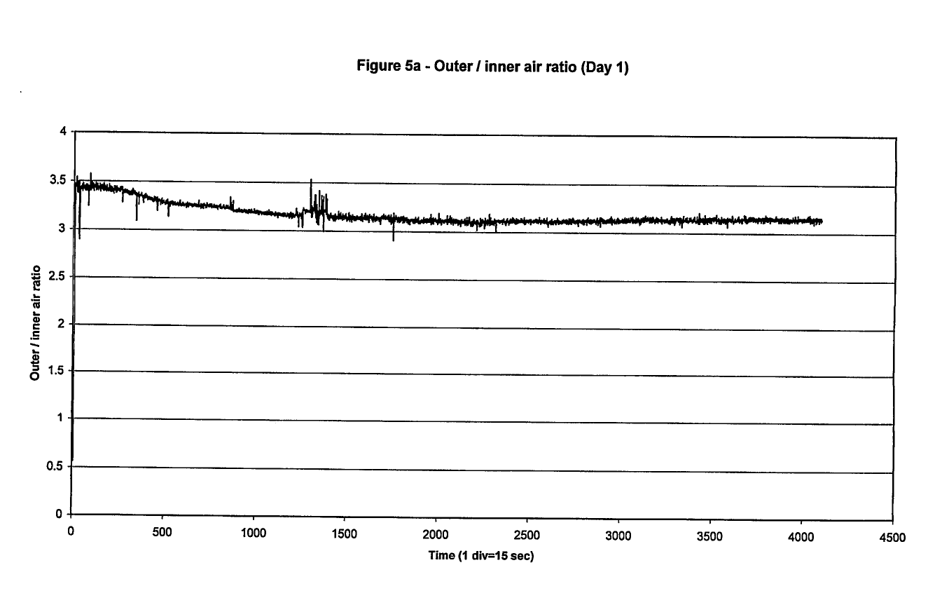

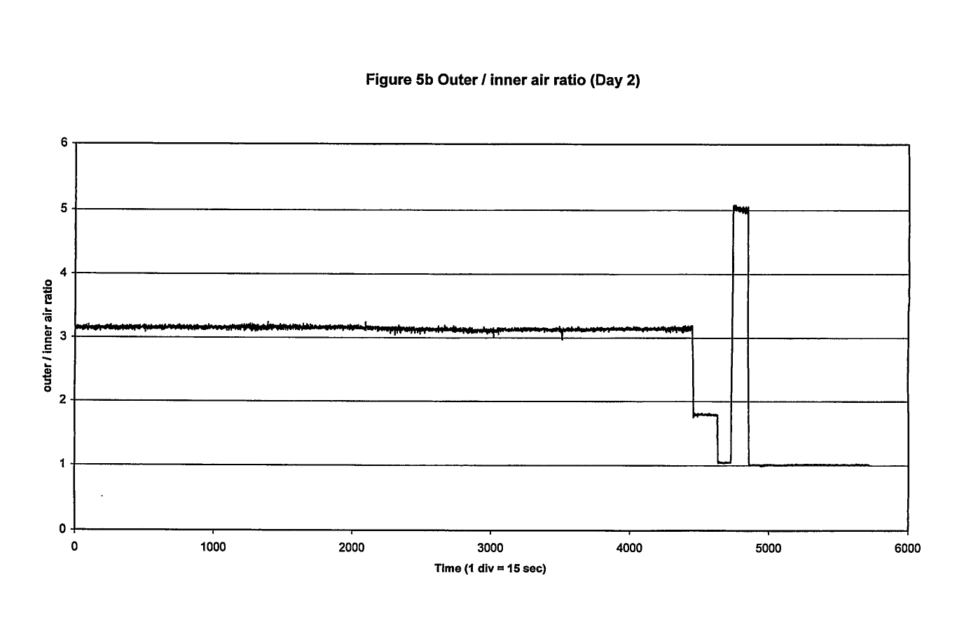

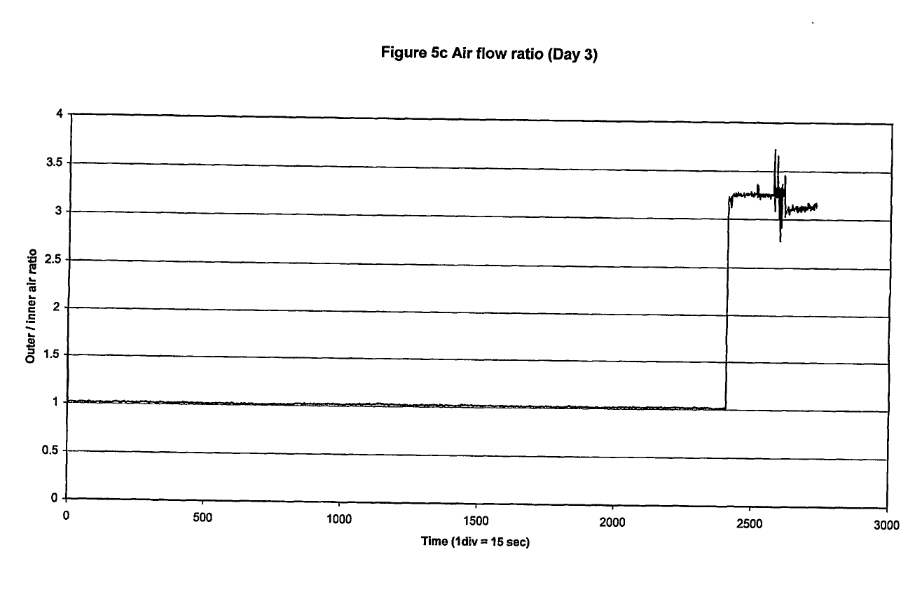

FIG. 5a demonstrates the initial set-up of the burner with a primary: secondary air ratio of around 3:1. This was subsequently reduced to approximately 1:1 as part of the test protocol.

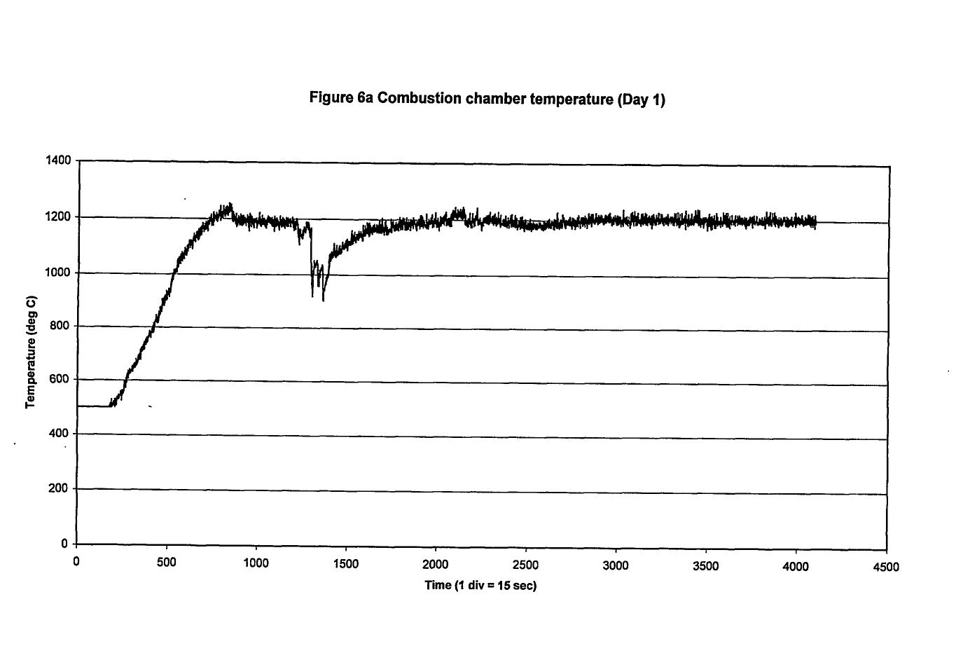

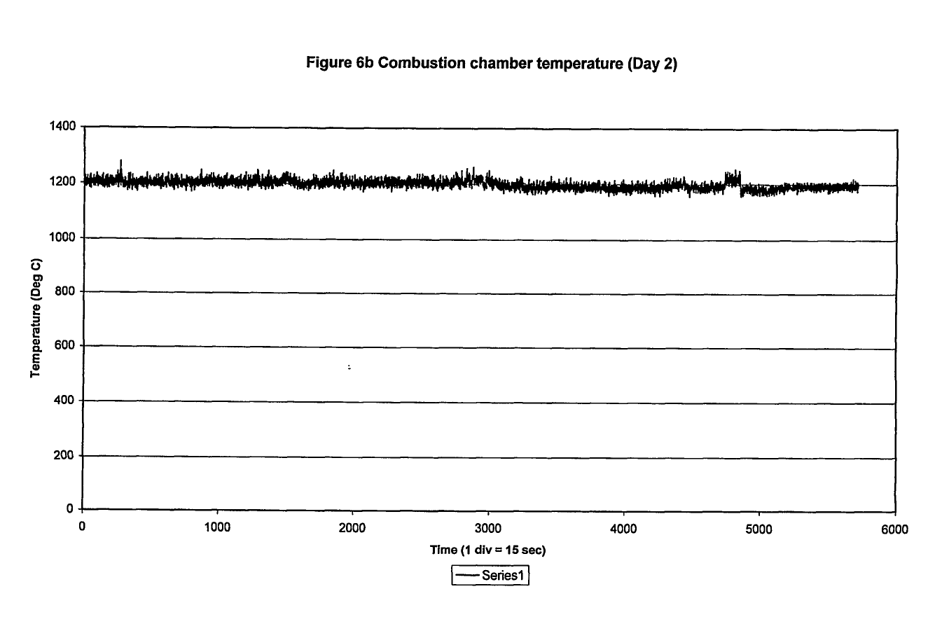

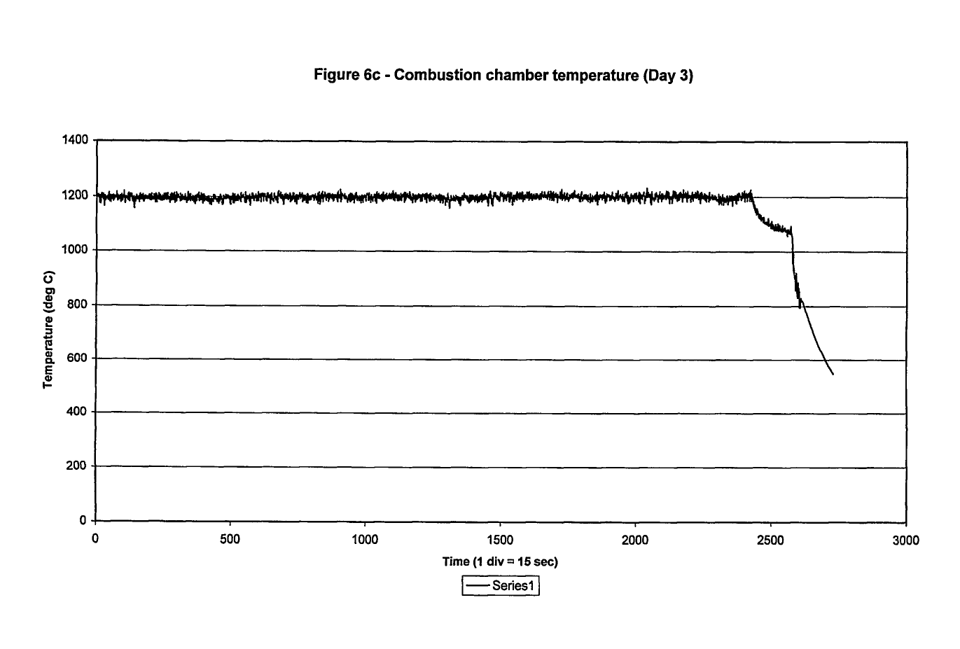

Combustion chamber temperatures shown in FIGS. 6a, 6b, and 6c are notoriously difficult to measure accurately largely because of the problem of accurate location and calibration of the measurement device.

As can be seen from the figures, there is some noise on the signal (approximately +/−20° C. about the mean value) but this is to be expected and reflects the general noise and variability associated with flames.

A number of thermocouples are located down the length of the fluegas duct and are used to measure the temperature of the fluegas. Heat is removed from the fluegas duct with the profile said to mirror that of a typical power station boiler.

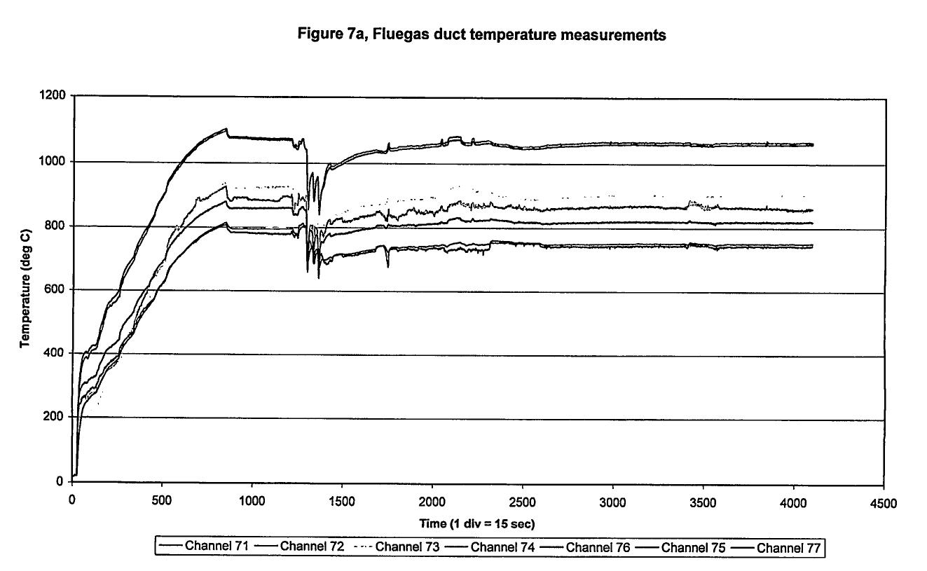

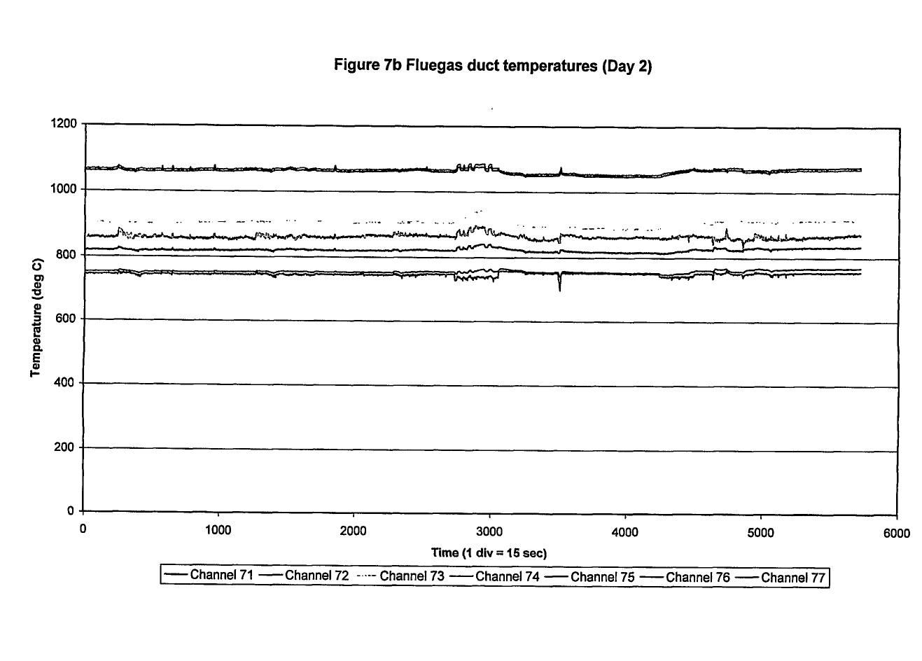

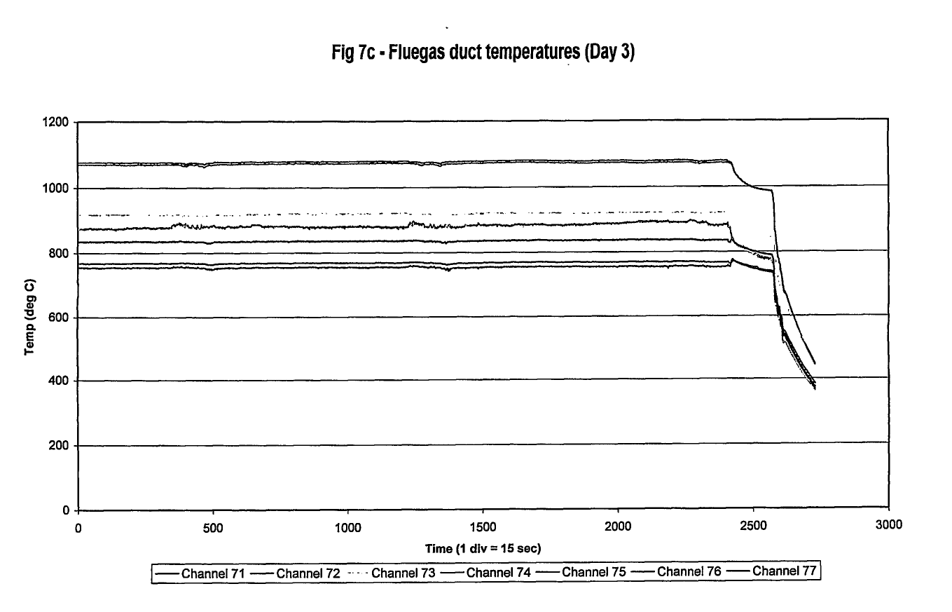

FIGS. 7a, b & c show the temperature profiles for the duration of the trials. As can be seen, the exit temperature reduces to around 740° C., which only represents a small part of the total heat recovery from the fluegas in a typical boiler. However, the heat transfer area is fixed and any differences in temperature drop between the exit from the combustion chamber and the exit from the unit under various operating conditions can be considered to be representative of changes in overall heat transfer efficiency.

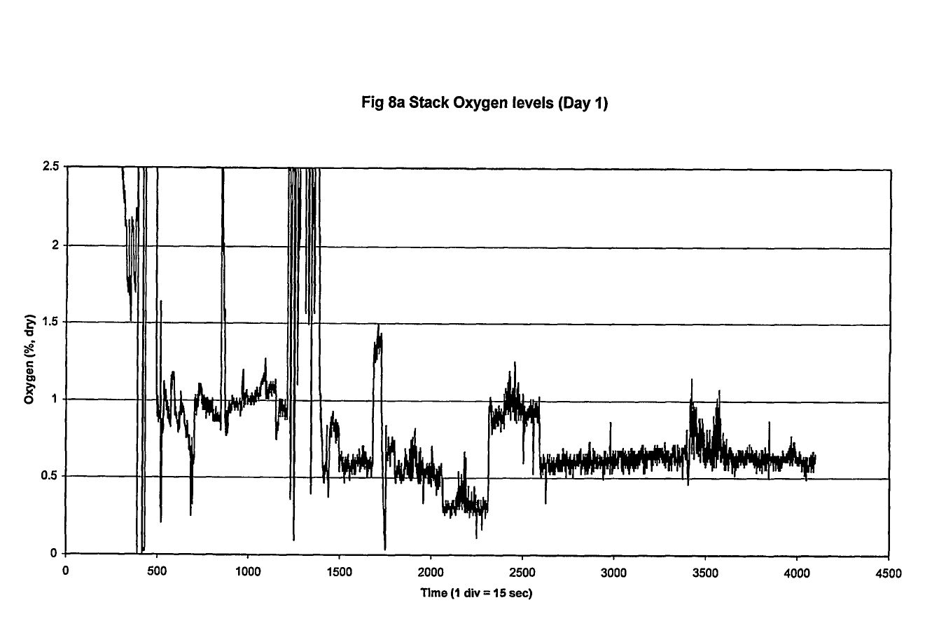

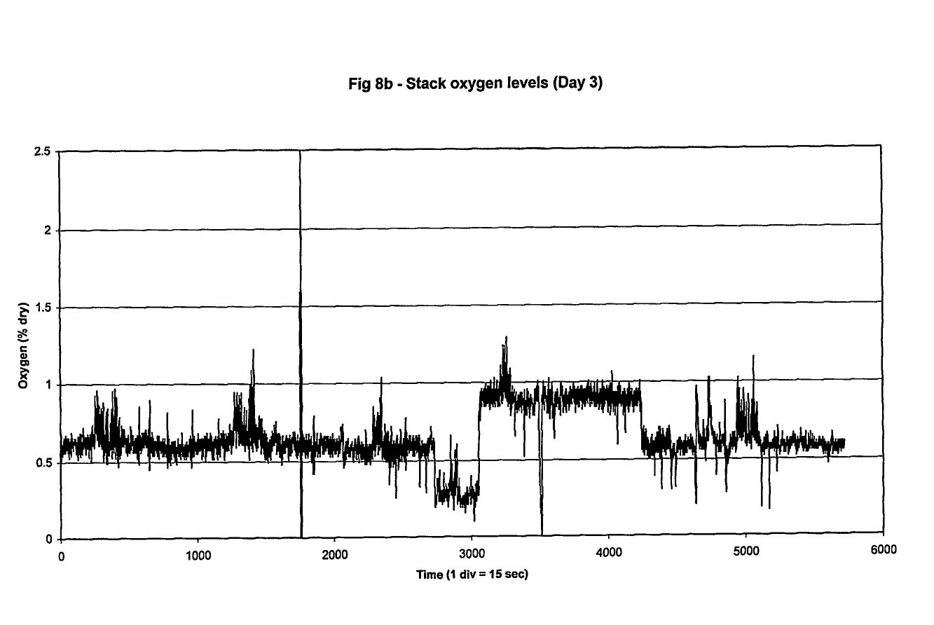

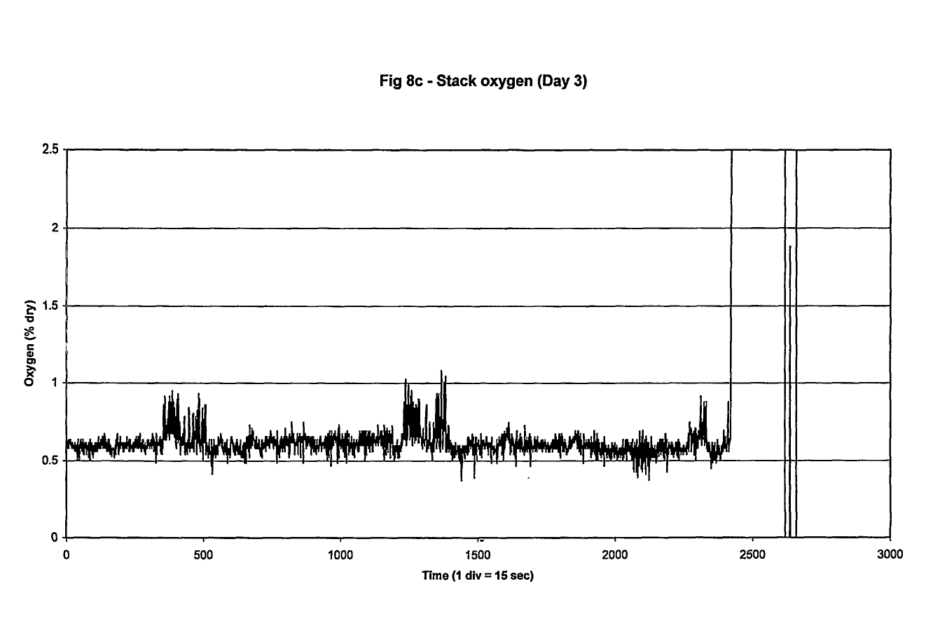

FIGS. 8a to 8c show stack oxygen. Some degree of ‘noise’ is apparent from these figures as is to be expected, however, overall control is good. Overall, the varying operating regimes can be seen corresponding to stack oxygen levels of 0.3, 0.6 & 0.9%.

It is important to stress that these stack oxygen levels are significantly less than those which would normally be encountered on typical industrial boiler plant.

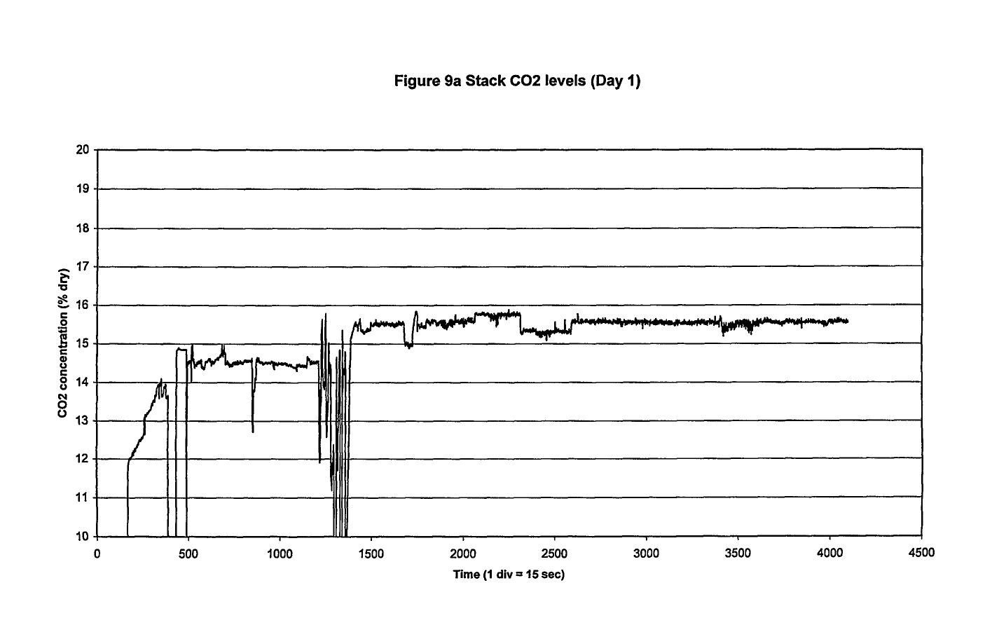

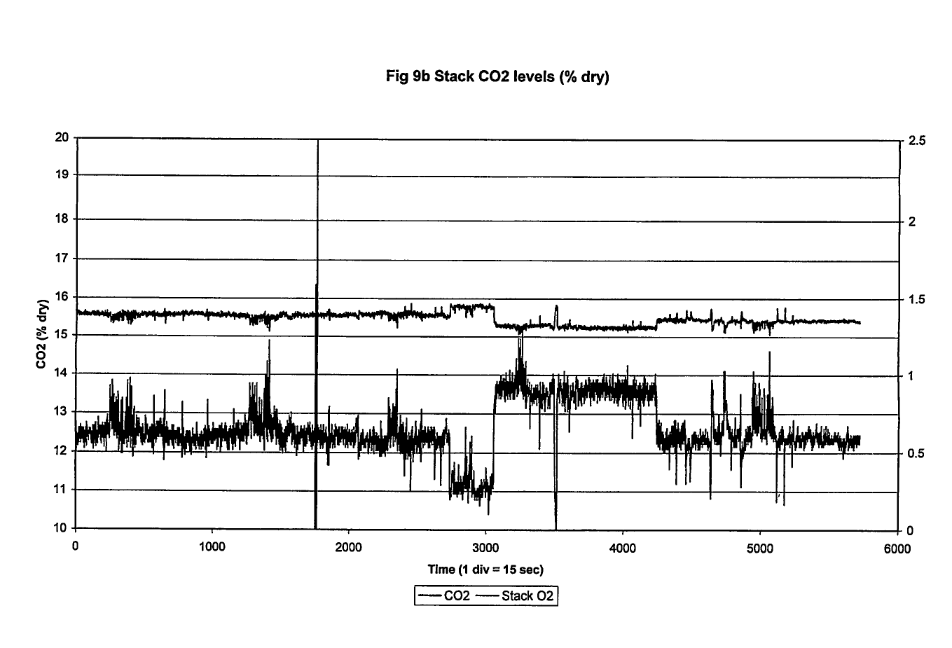

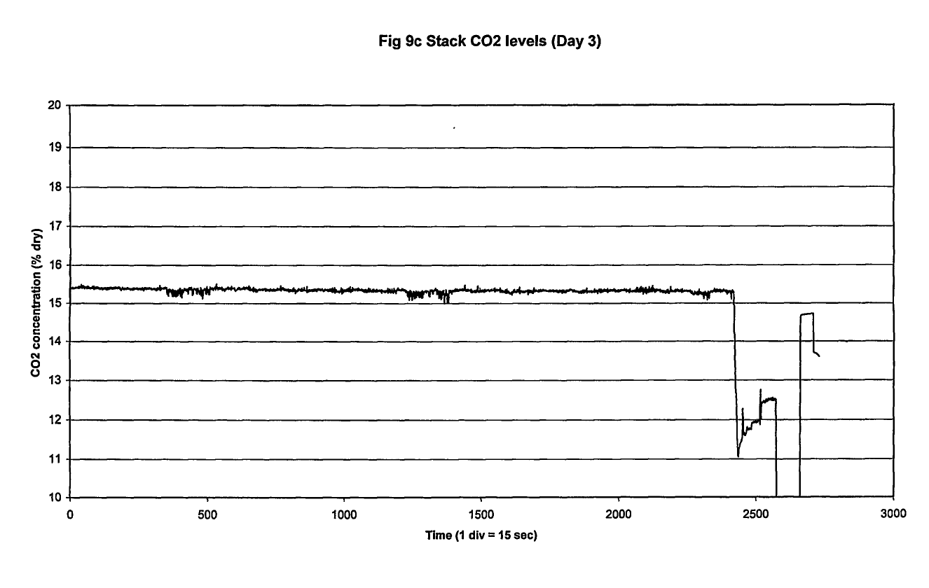

FIGS. 9a to 9c show the corresponding CO₂ levels for the duration of the tests.

FIG. 9b includes the stack oxygen level for comparative purposes and it can be seen that as expected, the CO₂ concentration increases as the stack oxygen decreases in line with the change in dilution factor.

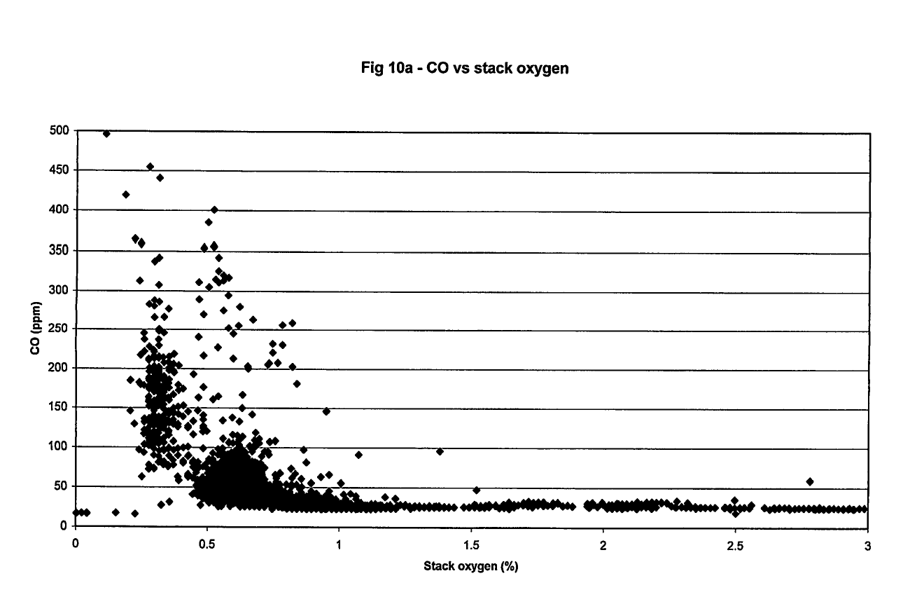

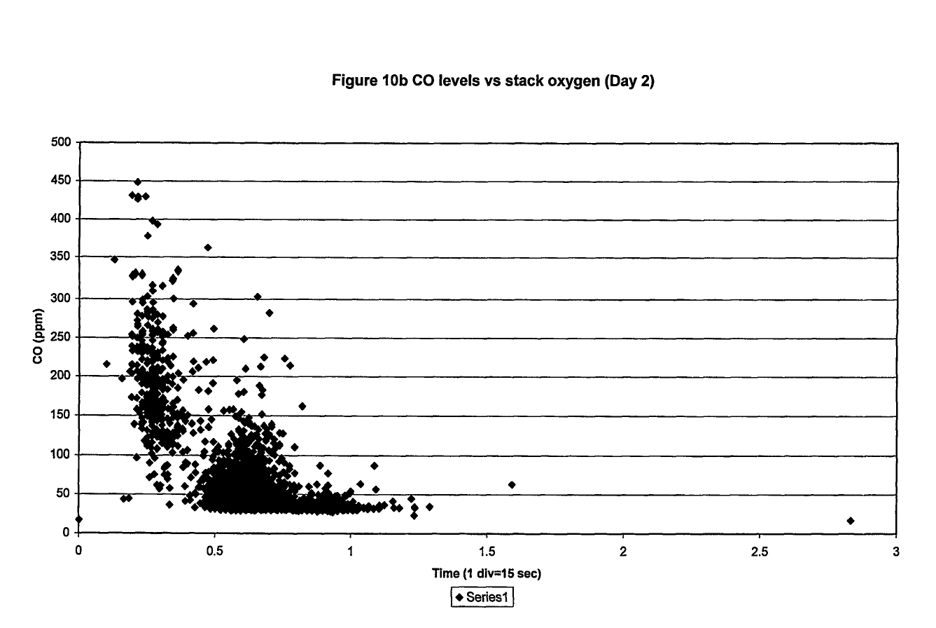

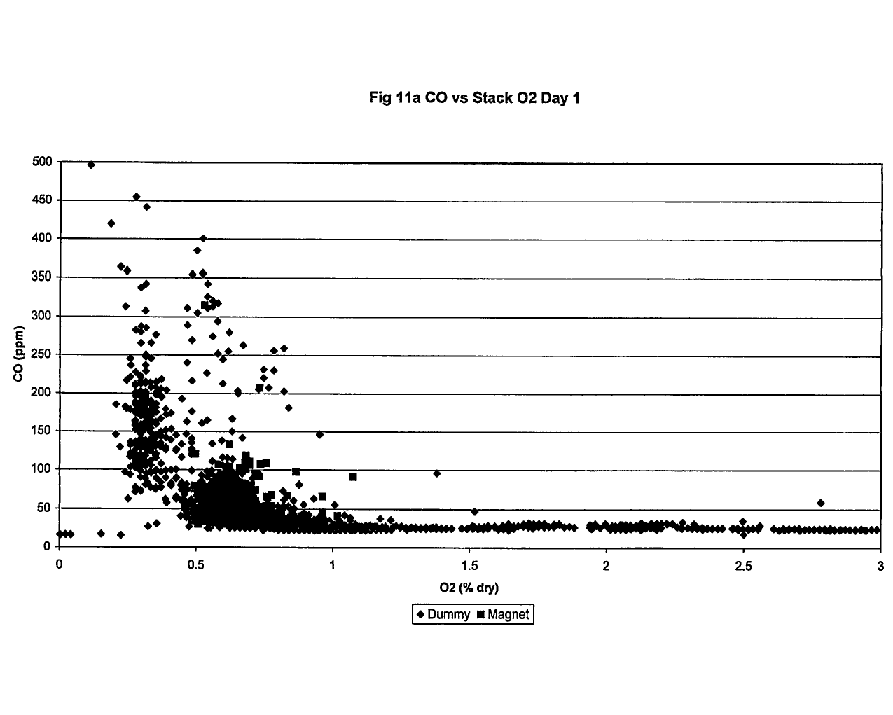

FIGS. 10a, 10b, and 10c show the overall results for CO plotted vs. stack oxygen. As expected, for oxygen levels in excess of around 1%, CO levels are negligible at around 30 ppm.

As stack oxygen levels are reduced to 0.3-0.6%, so the CO levels increase as would be expected. A very wide spread of results is apparent when operating at low stack oxygen levels.

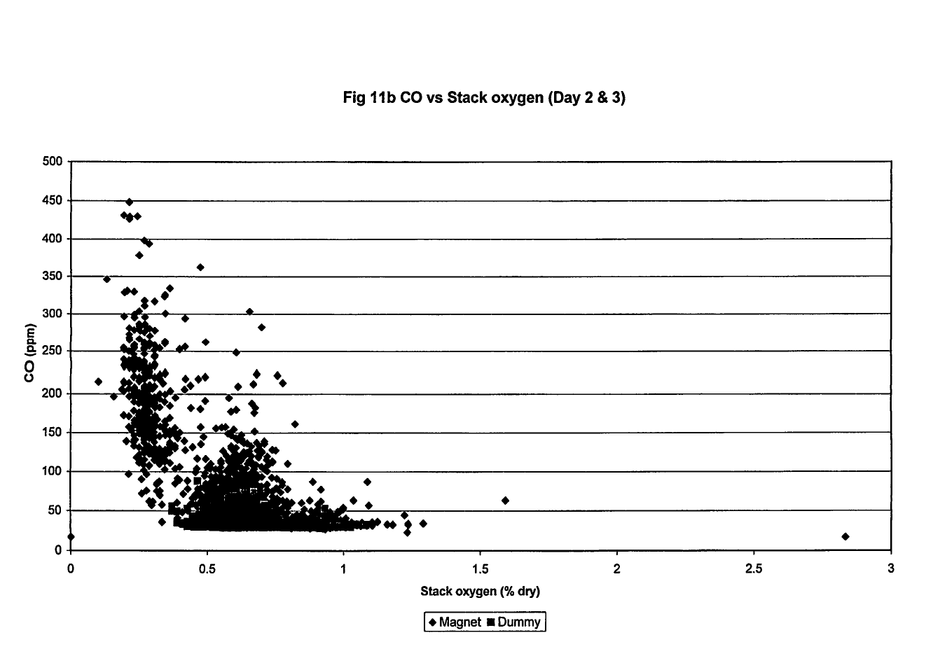

FIGS. 11a & b illustrate CO vs. stack oxygen differentiated by use (or otherwise) of the magnetic enhancement device.

From FIG. 11a it is apparent that there is no obvious or significant change in CO levels when the magnetic device is commissioned. FIG. 11b (results for days 2 & 3) appears to show a marked reduction in measured CO levels on switching back to the dummy unit, which is counter-intuitive unless there has been some other effect in the interim.

Potential effects include a delay period which has resulted in activation of the feed pipework or a consequence of the change in secondary: Tertiary air ratio.

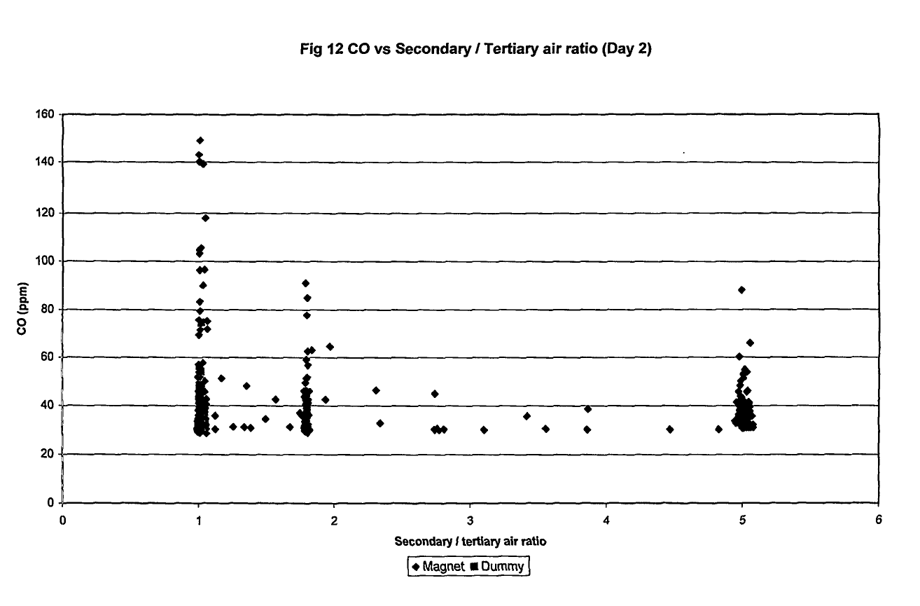

FIG. 12 shows CO level as a function of secondary tertiary air ratio for day 2 (the only day for which such data are available). It can be seen that there is some evidence for an increase in the range of CO readings when the magnet is in operation although the minimum readings remain unaltered. It should be noted that the absolute levels remain extremely low for operation both with and without the magnets when compared to typical industrial applications. It should also be noted that there is a general increase in CO levels as the secondary:tertiary air ratio is decreased.

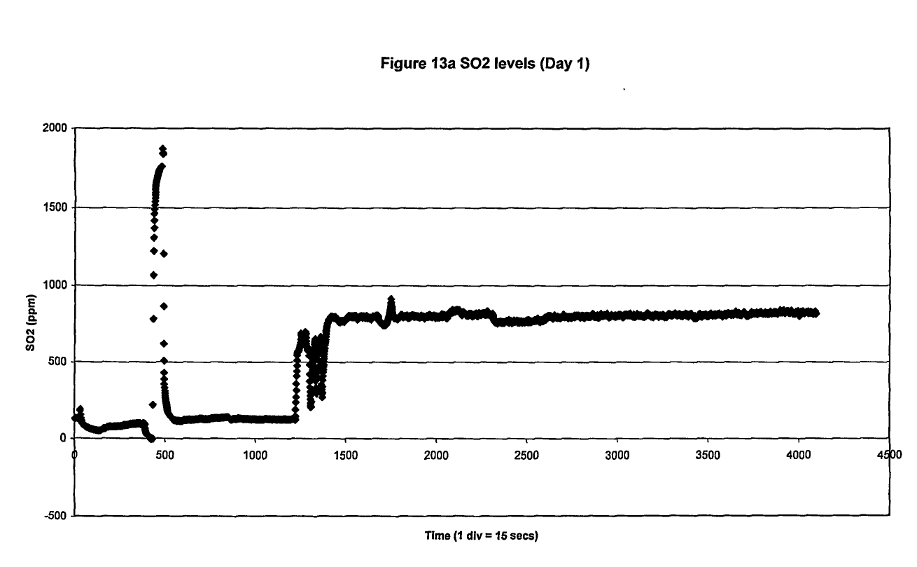

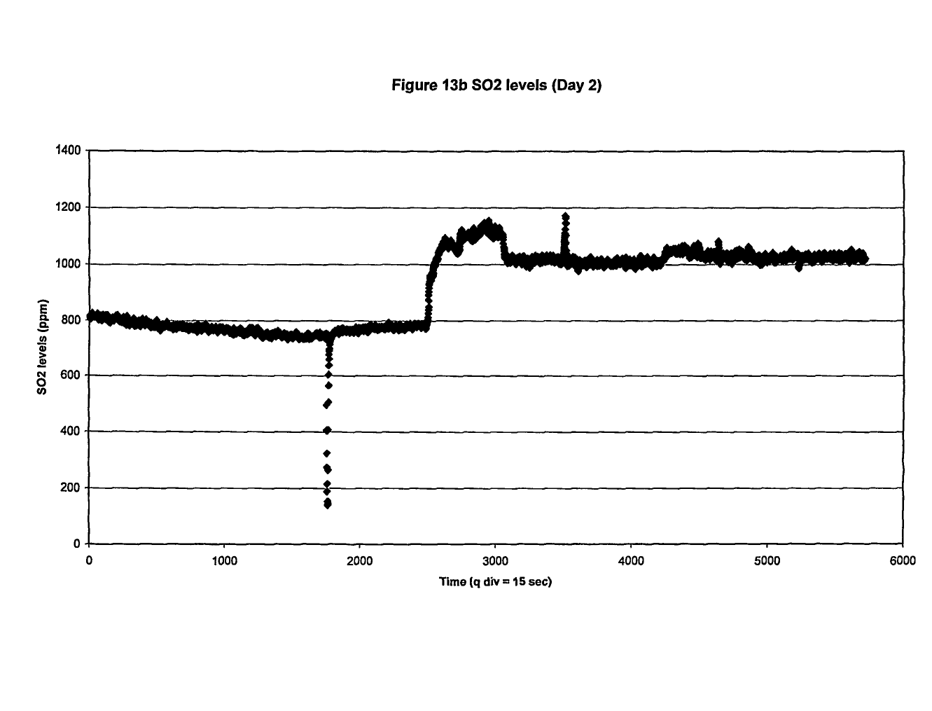

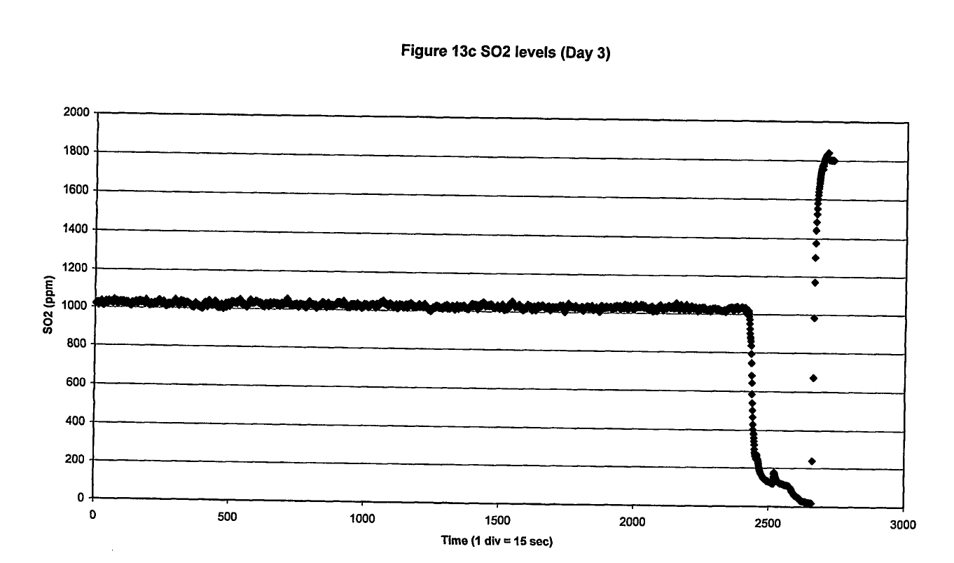

FIGS. 13a, 13b, and 13c plot the SO₂ levels as measured at the U tube outlet. SO₂ levels are effectively determined by the sulphur content of the feed fuel oil. The sharp increase in SO₂ level during Day 2 is attributable to a change in fuel oil composition between samples 2 & 3 as evidenced from the fuel analysis table below.

TABLE 1
Fuel analysis

| Analyte | 1 | 2 | 3 | 4 |
|---|---|---|---|---|
| Ash content | 0.03 | 0.05 | 0.08 | 0.06 |
| Asphaltenes | 7.42 | 7.44 | 8.92 | 8.78 |
| Carbon | 87.45 | 87.47 | 87.08 | 86.98 |
| Gross CV | 42,547 | 42,610 | 42,530 | 42,577 |
| Hydrogen | 10.44 | 10.45 | 10.39 | 10.39 |
| Nitrogen | 0.63 | 0.56 | 0.59 | 0.62 |
| Sulphur | 0.82 | 0.89 | 1.12 | 1.26 |
| Viscosity @ | 667.72 | 679.70 | 719.72 | 736.96 |
| 40° C. | | | | |

NOₓ emissions arise from a number of complex formation mechanisms and thus NOₓ levels are influenced by a number of factors.

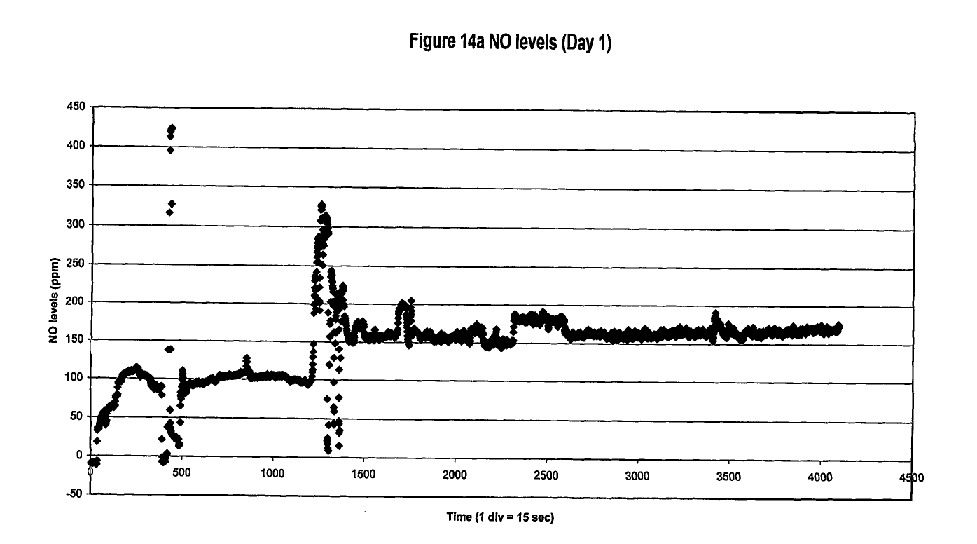

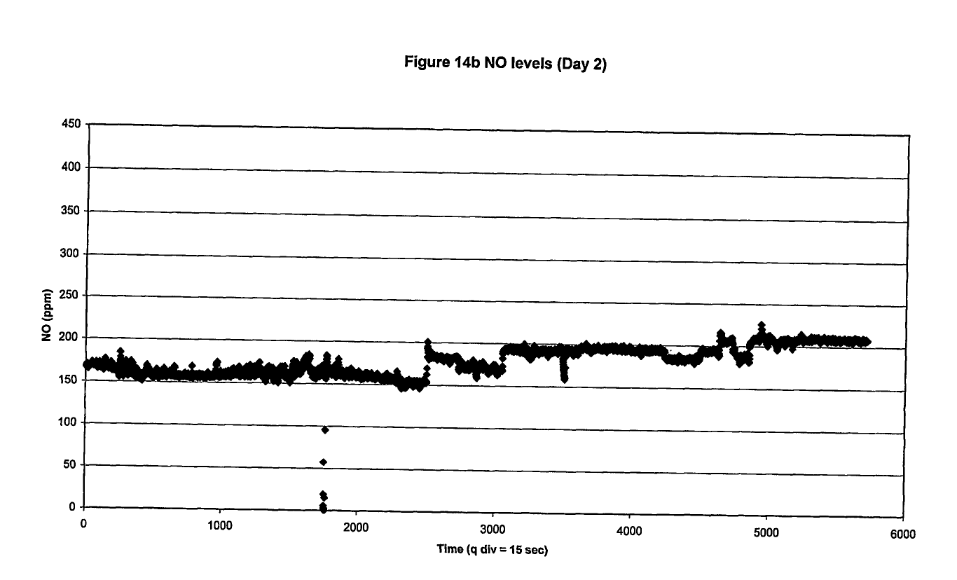

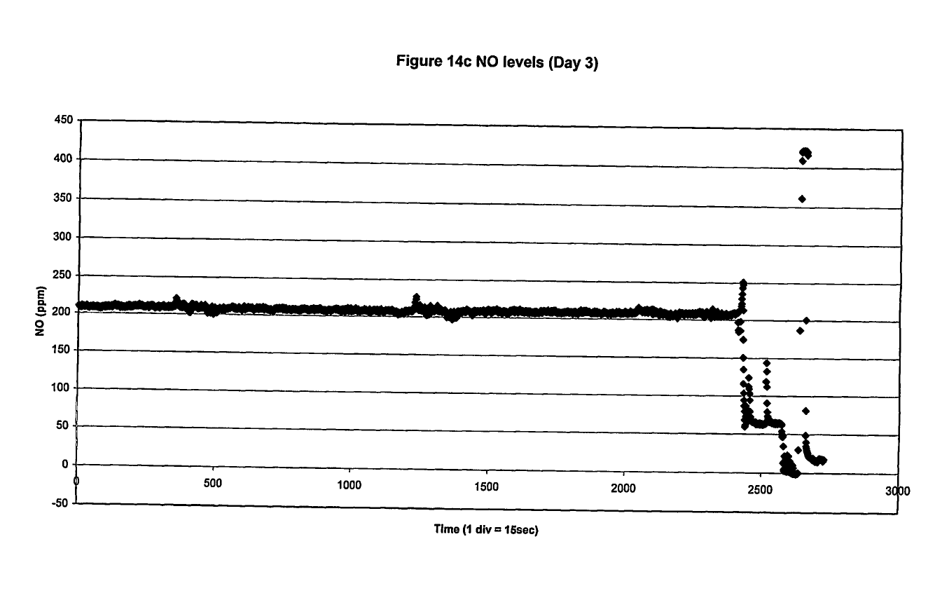

FIGS. 14a, 14b, and 14c plot NOₓ levels for the duration of the tests. FIG. 14a shows considerable variability in NOₓ levels during the commissioning and set-up operations but that the levels stabilising somewhat as operation becomes established.

FIG. 14b (Day 2) shows a generally rising trend of NOₓ levels whilst 14c (Day 3) shows remarkably stable operation until the shut-down sequence was initiated.

Days 1 & 2 are of particular interest since they include operation at a number of different operating conditions with respect to excess air and secondary:tertiary air ratio.

In an attempt to differentiate between the different factors influencing NOₓ formation, the results have been replotted against stack oxygen level and secondary tertiary air flows.

FIGS. 15a & b plot NO level against stack oxygen level and from these figures it is apparent that the magnetic device is having no significant effect on NO levels.

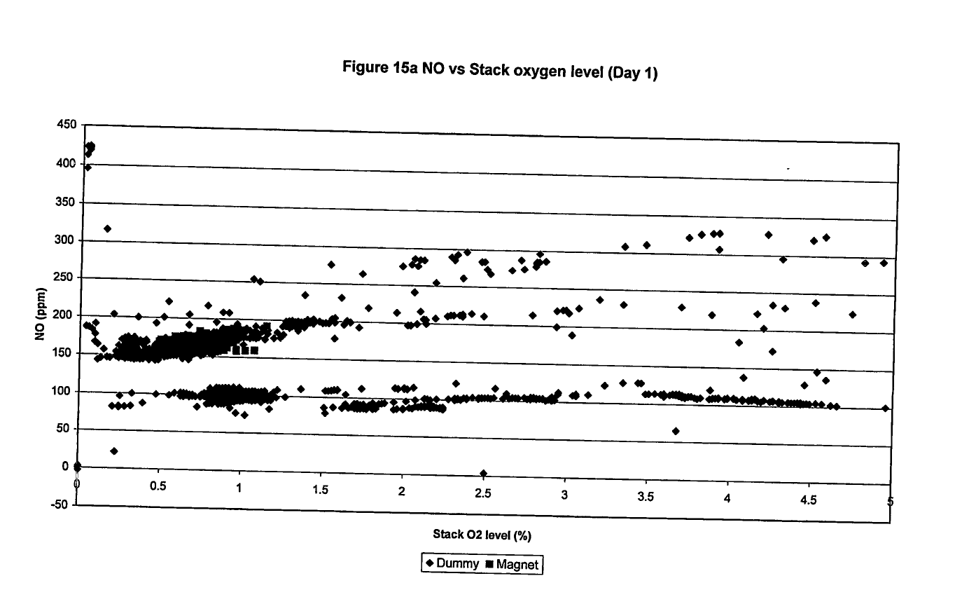

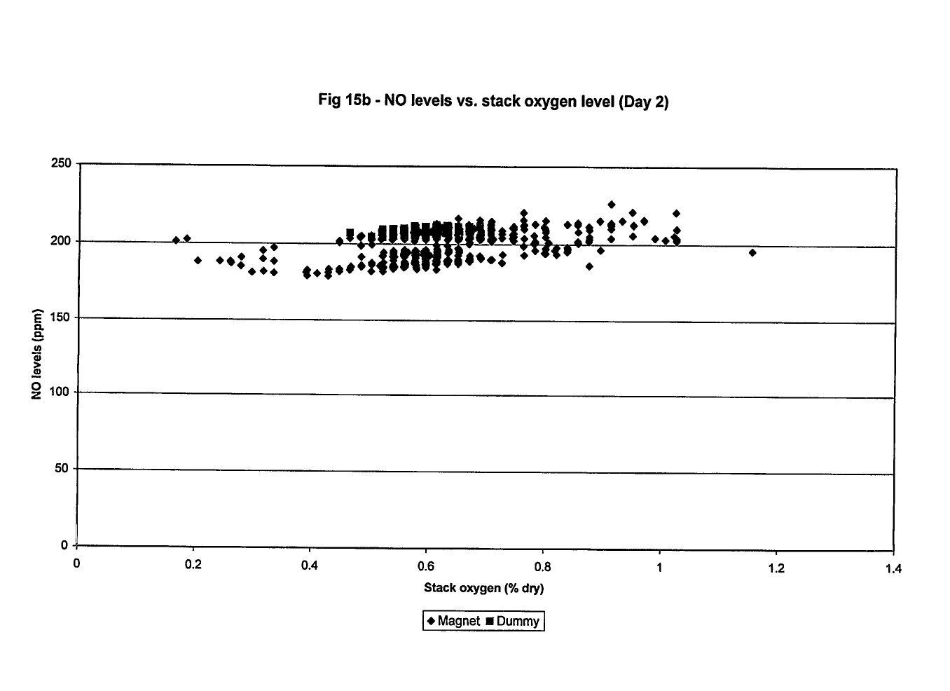

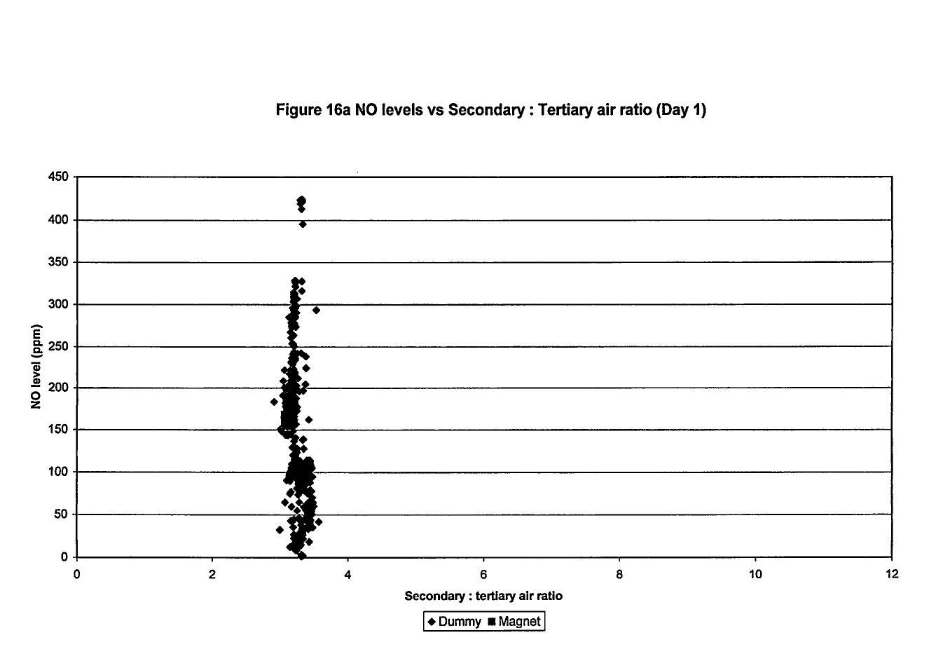

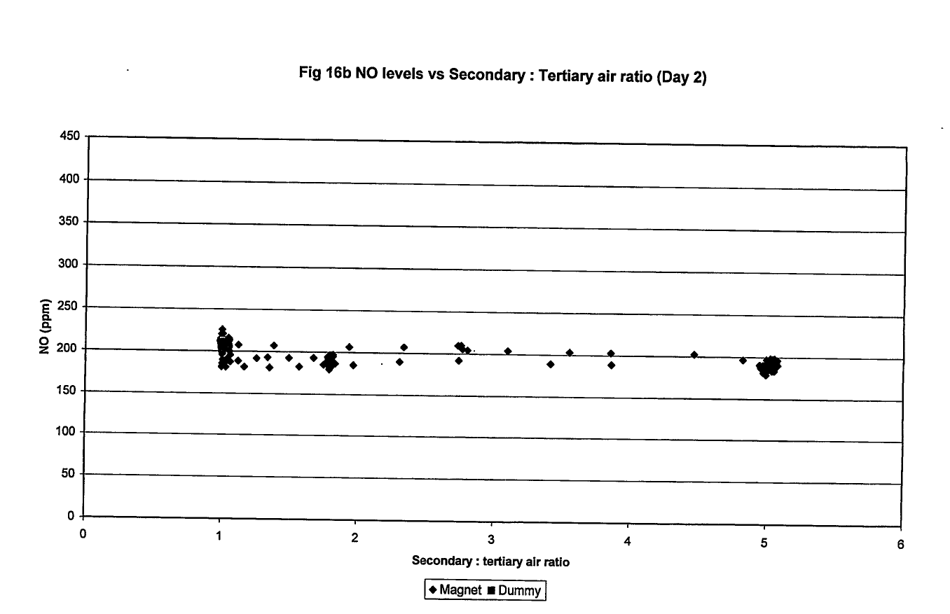

Similarly, FIGS. 16a and 16b show no significant variation in NO levels as a consequence of changes in the secondary:tertiary air ratio although there is some evidence to suggest a smaller variability in NO levels.

A number of temperature measurements are available at points through the experimental rig. Gas temperatures are measured using a Cyclops single colour infra-red pyrometer together with a number of ceramic sheathed thermocouples located sufficiently far into the gas stream to give a reliable reading of gas temperature.

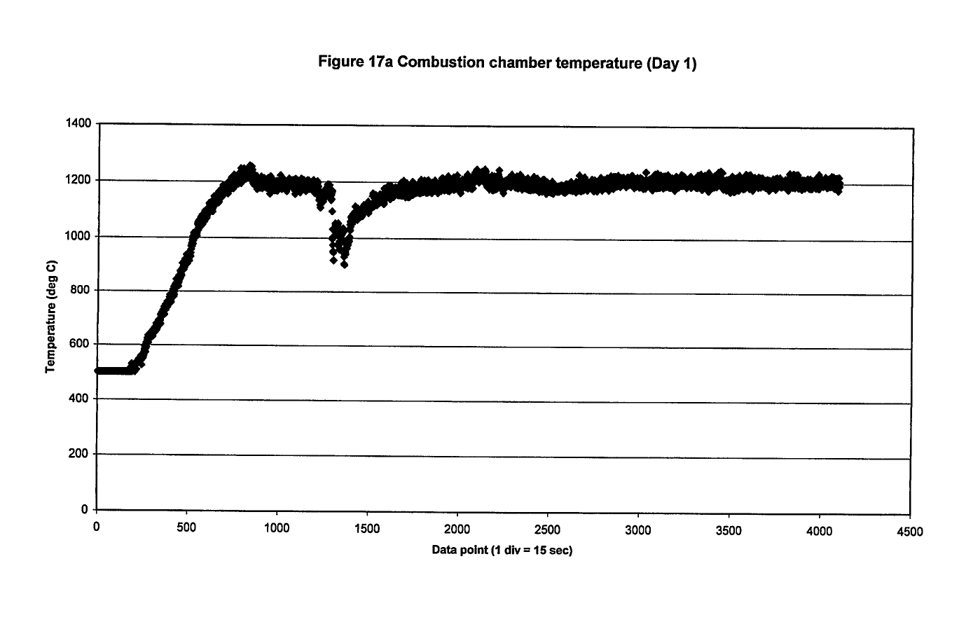

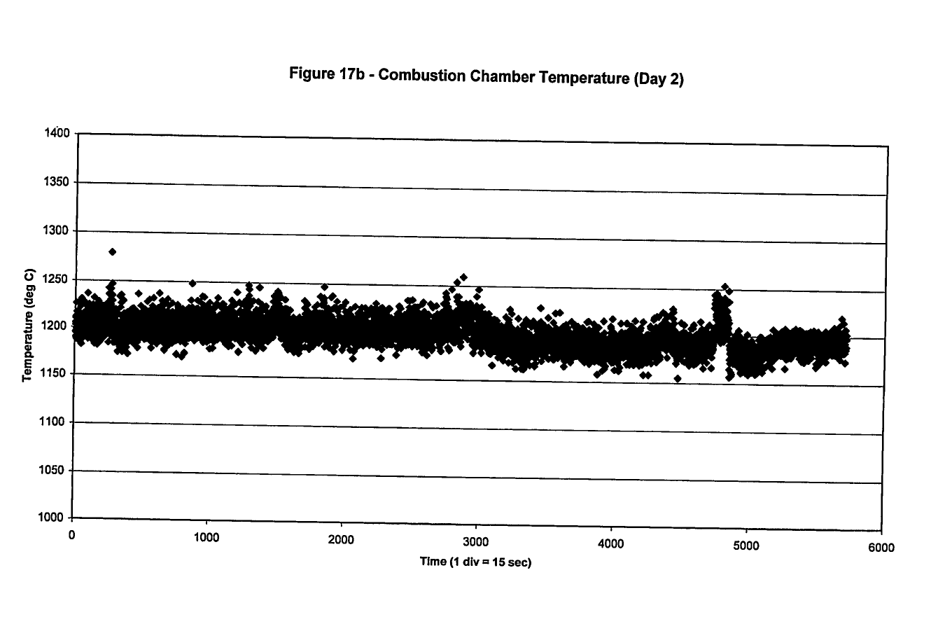

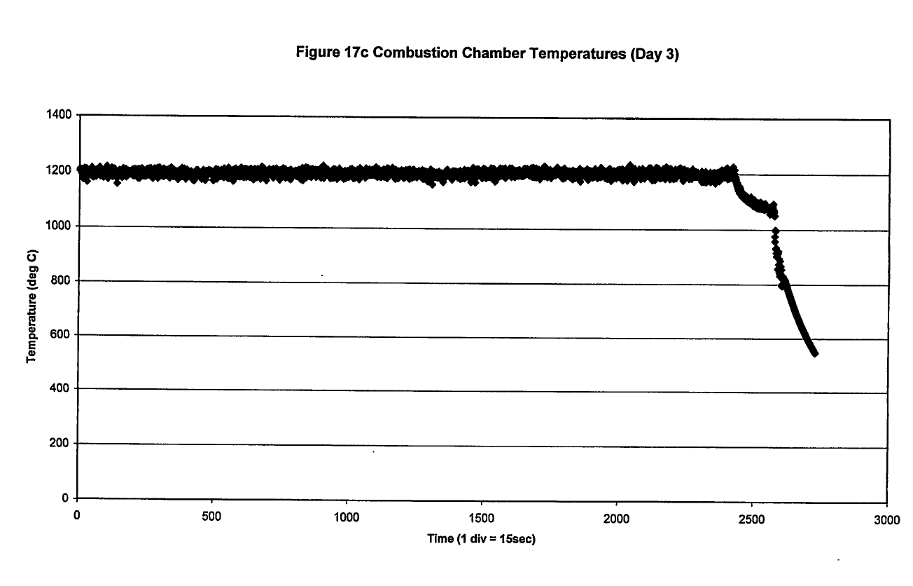

Temperature data is plotted in FIGS. 17a, 17b, and 17c for the 3 days of the experimental work which shows the basic variations in temperature during the course of the tests.

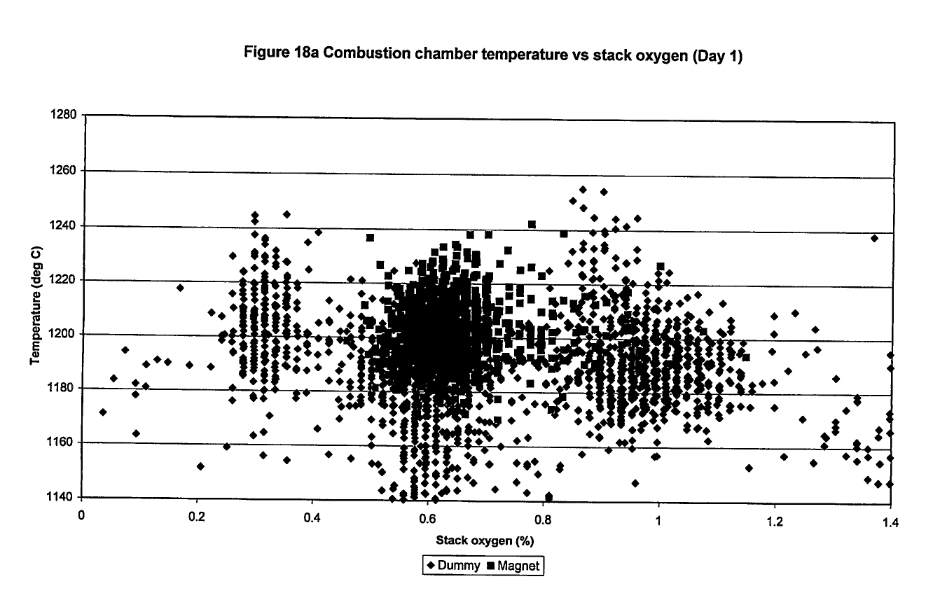

FIGS. 18a and 18b show the combustion chamber temperature data replotted as a function of stack oxygen content with magnet and dummy unit results differentiated.

For Day 1 (FIG. 18a), the comparative data relates to a stack oxygen content of 0.6% and it is apparent by inspection that the flame temperature with the magnet is higher than that for the dummy unit.

This conclusion is born out by statistical analysis of the results which demonstrates that at the 99% confidence level (i.e. there is a 1% chance of the conclusion being invalid), the mean flame temperature for the system with the magnet is greater (in this case by around 15° C.) than for the system operating with the dummy unit (see Table 1)

Having established the base line performance of the system with fuel flowing through a dummy housing with no magnets, the magnetic fluid treatment device ‘active’ conditioning units (device 1 and device 2) were tested.

The test durations are summarised in Table 1.

TABLE 2
Comparison of combustion chamber temperature for
dummy and Device 1 (Day 1)

| | | Magnet (device 1)/ |
|---|---|---|
| | Dummy/° C. | ° C. |
| Mean | 1186.5 | 1201.8 |
| Standard Deviation | 10.7 | 19 |
| No. of data points | 1406 | 1093 |

Applying a two population inference test for the null hypothesis that mean (magnet)−mean (dummy)=0 (i.e. populations are the same), shows that at the 99% confidence level, the difference in mean values of the populations is in fact 15.25 to 15.35. Since the null hypothesis value (0) lies outside this range, it can be concluded at the 99% confidence level that the mean values for the two populations are different. There is, therefore, evidence that the flame temperature is increased by the application of the magnetic fuel pre-treatment device.

The corresponding data for Day 2 appear to show a counter effect, i.e. that the flame temperature is the same or perhaps marginally higher for the case of operation with the dummy rather than the magnetic unit as shown in Table 2.

TABLE 3
Comparison of combustion chamber temperature for
dummy and magnet (device 1) (Day 2)

| | Dummy | Magnet (device 2) |
|---|---|---|
| Mean | 1193.0 | 1190.7 |
| Standard Deviation | 8.1 | 15.5 |
| No. of data points | 764 | 416 |

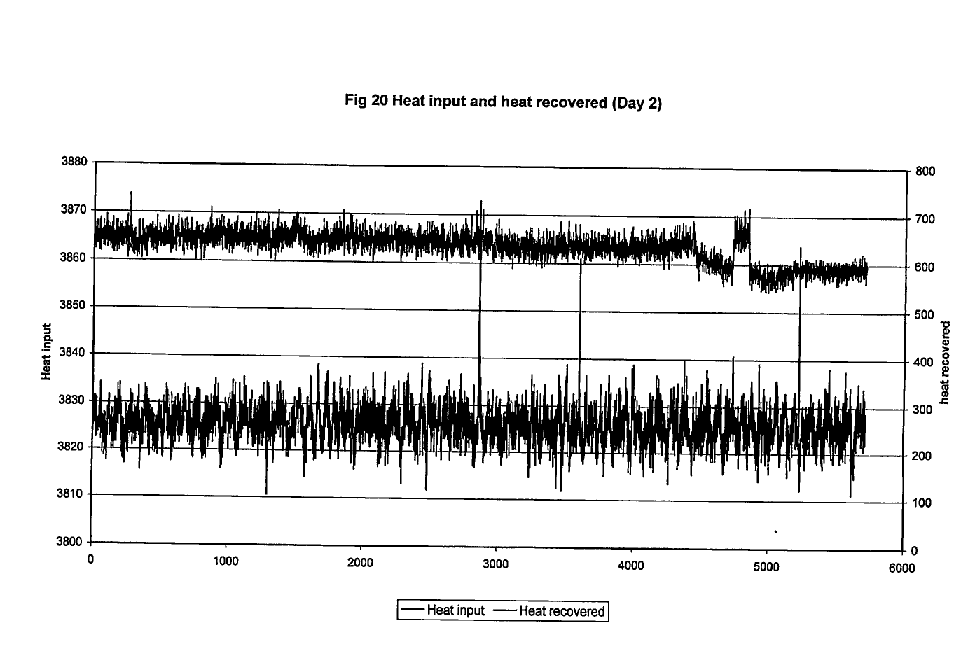

Further analysis shows that due to changes in stack oxygen levels and secondary:tertiary air levels undertaken in an attempt to realise the full potential results from the system, it is not possible to make meaningful comparisons between the magnet/non magnet condition due to lack of consistent operating data for the magnet condition. The variation in stack oxygen levels and secondary:tertiary air flows is shown in FIG. 20.

For a system such as the test facility with a fixed heat transfer area, a crude measure of overall thermal efficiency for comparative purposes can be defined as follows:—
Efficiency=Heat recovered/heat input

Where heat input can be defined as fuel flow multiplied by the calorific value of the fuel.

This definition excludes the effect of changes in input air flow and temperature, however, in this case, it has been shown that changes in inlet air temperature are negligible and for comparisons in efficiency made based on a constant fuel flowrate and stack oxygen level, these effects can be ignored.

Heat recovered is defined for the purposes of this comparison as follows:—
Heat recovered=fluegas mass flowrate×fluegas average specific heat capacity×temperature difference(combustion chamber to stack)

By definition, in the absence of any air leakage, the total fluegas flowrate is the sum of the fuel mass flowrate and the total air flow (both measured directly).

Although the specific heat capacity of the fluegas varies with temperature, because the difference in stack discharge temperature is small compared to the absolute value, it is permissible to use a fixed average value of fluegas specific heat capacity for the purposes of comparison.

Fluegas temperature difference is defined as the difference between the combustion chamber temperature and the average of the exit temperatures.

Whilst the above calculation does not represent an absolute determination of the thermal efficiency of the test unit, it provides an adequate basis for the comparison of performance under different conditions given that great care has been taken to ensure similarity of operating conditions elsewhere through the system (something not generally found on industrial boiler plant).

Two periods have been selected for comparative purposes as follows reflecting device 1 (Day 1) and device 2 (Day 2).

TABLE 4
efficiency of the magnetic fluid treatment
device, Day 1 - device 1.

| | Dummy | Device 1 |
|---|---|---|
| Average stack oxygen | 0.6 | 0.6 |
| (dry %) | | |
| No of data points | 293 | 1200 |
| Average efficiency | 17.8 | 18.1 |

It is apparent that a small increase in efficiency is apparent from these results as a consequence of the application of device 1.

Applying a two population inference test for the null hypothesis that average efficiency (device 1)−average efficiency (dummy)=0 (i.e. populations are the same) shows that at the 99% confidence level, the difference in mean values of the populations is in fact 0.10 to 0.497. Since the null hypothesis value (0) lies outside this range, it can be concluded at the 99% confidence level that the mean values for the two populations are different.

There is, therefore, evidence that the application of the magnetic fluid treatment device had a beneficial effect on efficiency.

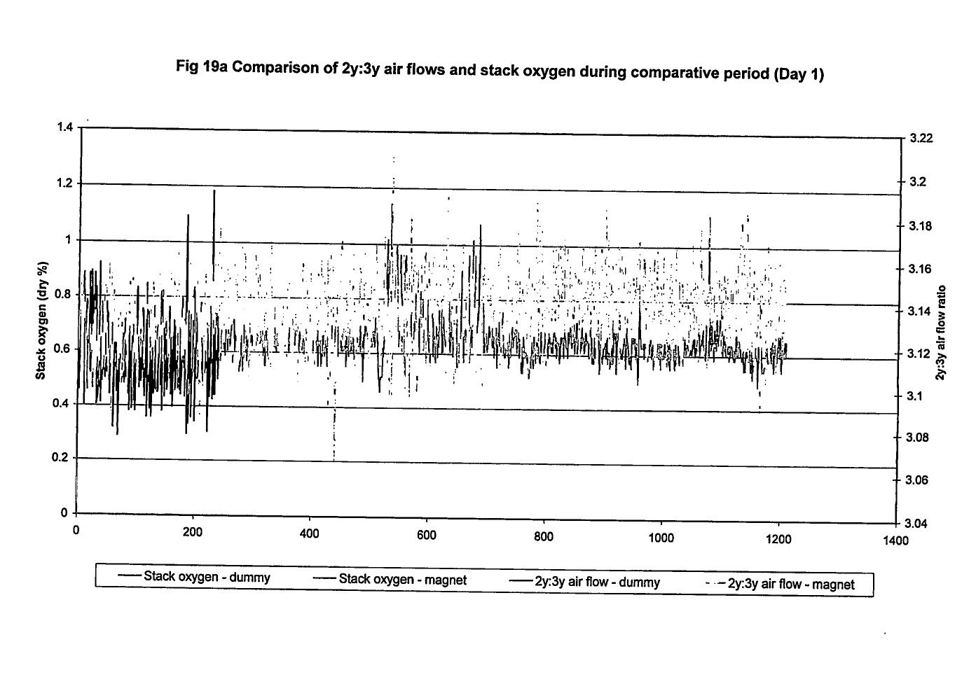

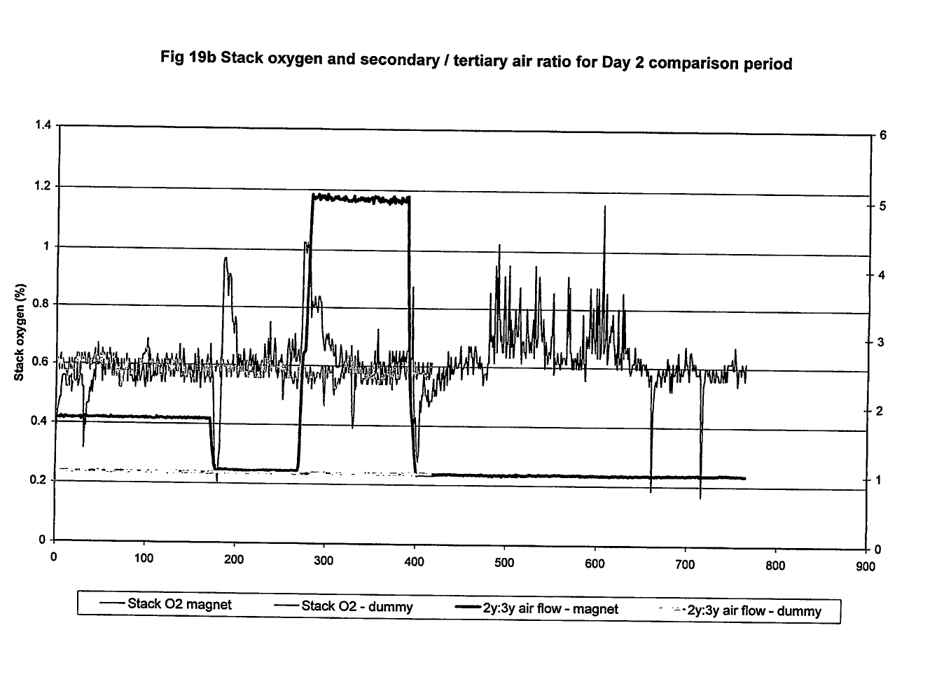

TABLE 5
efficiency of the magnetic fluid treatment
device, Day 2 - Device 2.

| | Dummy | Device 2 |
|---|---|---|
| Time span | 22:15-midnight | 21:25-21:55 |
| Av. stack oxygen | 0.6 | 0.6 |
| (dry %) (FIG. 19b) | | |
| Avg | 1 | 1 |
| secondary:tertiary | | |
| air flow ratio | | |
| No of data points | 416 | 120 |
| Average efficiency | 15.4 | 15.31 |
| Standard deviation | 0.289 | 0.279 |

These results appear to show a very slight drop in efficiency with the application of the device 2, a conclusion which is confirmed to be true to a confidence level of 99% (just). However, due to other changes in the system being undertaken at the time, there was comparatively little steady state data available for the device 2 condition. It is also apparent that the overall efficiency is significantly lower than for the Day 1.

Analysis of FIG. 20 shows that whilst total heat input remains pretty much constant, the heat recovered changes significantly during the period at the latter end of the day when these results were collected. Reference to FIG. 5b will show that this coincides strongly with the period when the outer/inner air ratio was being adjusted (secondary:tertiary air ratio).

Attempting to measure overall combustion efficiencies and (relatively) small scale changes are known to be notoriously difficult due to the number of different factors which can influence the results.

The test rig on which tests of the fuel were conducted represents an exceptional range of facilities by which the different parameters that affect combustion efficiency can be assessed and quantified.

As with all laboratory tests, the problem of the condition and set-up of the burner and establishing similar operating conditions to those typically found in the field remains to be resolved. In this case, despite the de-rating of the burner performance for the purposes of the test, it remains orders of magnitude better than any oil burner likely to be encountered in typical industrial service. The scope for any improvement in performance on the test rig is therefore far more limited than with a typical burner in industrial service.

Overall, apart from changes that were deliberately introduced, the performance of the test rig was very consistent.

There is statistically significant evidence that passing the fuel through device 1 resulted in a statistically significant increase in overall combustion efficiency under otherwise static conditions.

There is no significant evidence for changes in CO levels as a consequence of use of device 1 or device 2 that is independent of any other changes in operating conditions although once again it must be stressed that the observed CO levels are very significantly less than anything observed on typical industrial boiler plant.

Based on these results, it is therefore possible to say with 99% certainty that the magnetic devices 1 and 2 have improved combustion efficiency by 0.3 percentage points (approximately 1.7% overall) as shown in Table 4.

The magnetic fluid treatment device therefore has several advantages over the devices currently available for magnetic treatment of fuels. The magnetic fluid treatment device is a simple, cost-efficient, straight in-line device that enhances combustion across a range of units.

The increased efficiency demonstrated in the tests provides cost savings as the same amount of heat can be achieved with less fuel than other magnetic fluid treatment devices, or no device. The magnetic fluid treatment device, due to its more improved efficiency provides a cleaner burn resulting in lower maintenance for the combustion device.

The reduced fuel usage together with the cleaner burn has the effect of reducing emissions of harmful pollutants, like carbon dioxide, from the combustion process.

The magnetic fluid treatment device is also advantageous due to its easy installation. The device is contained within a specifically designed housing that allows insertion and removal in to an existing fuel pipe.

The magnetic fluid treatment device therefore has several advantages over the devices currently available for magnetic treatment of fuels. The magnetic fluid treatment device is a simple, cost-efficient, straight in-line device that enhances combustion across a range of units.

The increased efficiency demonstrated in the trials provides cost savings as the same amount of heat can be achieved with less fuel than other magnetic fluid treatment devices, or no device. The magnetic fluid treatment device is able to achieve fuel cost savings of greater than 5%, which should exceed the costs associated with installation and maintenance.

The magnetic fluid treatment device, due to its more improved efficiency provides a cleaner burn resulting in lower maintenance for the combustion device. This would lead to less downtime of the combustion device and therefore increased efficiency.

The reduced fuel usage together with the cleaner burn has the effect of reducing emissions of harmful pollutants, like carbon dioxide, from the combustion process.

The magnetic fluid treatment device is also advantageous due to its easy installation. The device is contained within a specifically designed housing that allows insertion and removal in to an existing fuel pipe or a new installation. The magnetic fluid treatment device provides improved combustibility to create the benefits of costs savings and greater efficiency of a combustion device.

In other embodiments the relative dimensions of the fluid supply pipe 7 and fluid channels 10, 11 of the embodiments shown in FIG. 21, can be changed in accordance with the invention described hereinbefore to yield apparatus having the benefits described above.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A magnetic fluid treatment device comprising at least one fluid channel, the or each fluid channel having at least two peripherally located magnets, the device being adapted to co-operate with a fluid supply conduit, so that, in use, fluid flowing through the fluid channel is subjected to a magnetic field; wherein the at least two magnets are located on opposite sides of the or each fluid channel and have a separation of less than about 90 mm.

2. A magnetic fluid treatment device comprising at least one fluid channel, the or each fluid channel having at least one peripherally located magnet; the device being adapted to cooperate with a fluid supply conduit, so that, in use, fluid flowing through the fluid channel is subjected to a magnetic field; the ratio of the cross-sectional area of the fluid supply conduit to the total cross-sectional area of the fluid channel or all of the fluid channels being in the range substantially 1:1.1 to substantially 1:2.8.

3. A magnetic fluid treatment device comprising at least one fluid channel, the or each fluid channel having at least one peripherally located magnet, the device being adapted to co-operate with a fluid supply conduit, so that, in use, fluid flowing through the fluid channel is subjected to a magnetic field; wherein a ratio of the width of the at least one fluid supply conduit to the length of a section of the at least one fluid channel along which the at least one magnet extends is in the range of substantially 1:20 to substantially 1:40.

4. A magnetic fluid treatment device comprising at least one fluid channel, the or each fluid channel having at least one peripherally located magnet, the device being adapted to co-operate with a fluid supply conduit, so that, in use, fluid flowing through the fluid channel is subjected to a magnetic field; wherein a magnetic field strength in a section of the at least one fluid channel along which the at least one magnet extends is between substantially 0.02T and substantially 1.0T.

5. A magnetic fluid treatment device as claimed in claim 1 wherein the at least two magnets have a separation of less than about 60 mm.

6. A magnetic fluid treatment device as claimed in claim 2 wherein the ratio of the cross-sectional area of the fluid supply conduit to the total cross-sectional area of the or all of the fluid channels is in the range substantially 1:1.2 to 1:2.4.

7. A magnetic fluid treatment device as claimed in claim 3 wherein the ratio of the width of the at least one fluid supply conduit to the length of a section of the at least one fluid channel along which the at least one magnet extends is in the range substantially 1:20 to 1:30.

8. A magnetic fluid treatment device as claimed in claim 4 wherein the magnetic field strength in the section of the at least one fluid channel along which the at least one magnet extends is between substantially 0.025T and 0.5T.

9. A magnetic fluid treatment device as claimed in claim 1 where the fluid is a fuel.

10. A magnetic fluid treatment device comprising at least one fluid channel, the or each fluid channel having at least one peripherally located magnet, wherein the at least one magnet is removably received in a body section of the device.

11. A magnetic fluid treatment device as claimed in claim 10 wherein the body section is non-ferrous.

12. A magnetic fluid treatment device as claimed in claim 10 further comprising at least one internal magnet within the fluid channel.

13. A magnetic fluid treatment device as claimed in claim 10 wherein the device is fitted within an existing fluid supply conduit.

14. A magnetic fluid treatment device as claimed in claim 10 wherein the device comprises one or more internal replaceable magnetic cartridges held in position inside the device by retaining means into which the removable magnet cartridge(s) will slot, wherein the or each internal replaceable magnetic cartridge splits the fluid channel into subsidiary channels.

15-16. (canceled)

17. A magnetic fluid treatment device as claimed in claim 10 wherein the ratio of the fluid flow area of the device and/or channels thereof to the fluid flow area of a fluid supply conduit to which the device is attached is substantially 1:1.2 to 1:2.5.

18-21. (canceled)

22. A magnetic fluid treatment device as claimed in claim 10 wherein the magnets inside the internal magnetic cartridge and/or external magnetic cartridge is/are arranged differently depending on the fuel passing through the magnetic field of the cartridges and a ratio of the width of the fluid supply conduit to which the device is attached to the length of a section of the fluid channel along which the at least one magnet extends.

23. A magnetic fluid treatment device as claimed in claim 10 wherein the arrangement of the polarity of the magnets inside the internal magnetic cartridge(s) and/or external magnetic cartridge(s) changes according to the fuel type and quality, fuel temperature, fuel pressure, time between magnetisation and combustion and/or required dwell length ratio of the device.

24. A magnetic fluid treatment device as claimed in claim 1 wherein the magnetic field(s) is applied substantially at right angles to the flow of fluid.
